(19) United States
(12) Patent Application Publication
(10) Pub. No.: US 2004/0129311 A1
(43) Pub. Date: Jul. 8, 2004

(54) Combined connector-pneumatic coupler-locking inflate/deflate valve series

(76) Inventor: William L. Courtney, Elk, CA (US)

Correspondence Address: Daniel S. Polley, Esq., Malin, Haley & DiMaggio, P.A., 1936 South Andrews Avenue, Fort Lauderdale, FL, 33316, US

(21) Appl. No.: 10/694,626

(22) Filed: Oct. 27, 2003

Related U.S. Application Data
(60) Provisional application No. 60/442,232, filed on Jan. 23, 2003.
(60) Provisional application No. 60/421,585, filed on Oct. 28, 2002.

(51) Int. Cl. F16K 21/00

(52) U.S. Cl. 137/223

(57) ABSTRACT

A partially inserted oral inflation-deflation valve with integrated or interchangeable pneumatic couplers allowing inflation from multiple compressed gas sources. The valve sleeve can be pneumatically sealed to the valve body, locking it open for pressurized use inline or to expedite deflation. The valve can be locked closed to maintain pressurized bladder integrity. The combined coupler valve may also include a continuous or intermittent use overpressure relief valve.

This application claims the benefit of and priority to U.S. Application No. 60/442,232, filed Jan. 23, 2003, and U.S. Application No. 60/421,585, filed Oct. 28, 2002, both of which are incorporated by reference.

### 1. FIELD OF THE INVENTION

This application relates generally to inflate/deflate valves and particularly to a combined connector-pneumatic coupler-locking inflate/deflate valve series having transient or continuous overpressure relief with complementary locking and non-locking dive jacket/dive regulator compressed gas air supply.

### 2. BACKGROUND OF THE INVENTION

Prior inflatable products inflated by compressed gas utilized locking or non-locking couplers. When the coupler was connected to a compressed gas source after passing though the coupler the gas then must pass through a check valve in order to retain the compressed gas within the bladder once the pressure source is removed from the coupler. This inline check valve prevented using the same locking or non-locking coupler for deflation. Thus, the bladder required an additional connector and deflation valve in order to deflate the bladder. An overpressure valve (“OPV”) is the third fitting required for the safe operation of bladders inflated by pressurized gas either at the surface or at depth. Inflatable products such as diver's life rafts, rescue mats and distress markers use a traditional large bore OPV which was designed to assure that the diver's jacket does not rupture during a rapid emergency ascent from 125 feet.

Current non-locking couplers incorporate a wide flange designed to allow the diver to hold the bladder and its no-lock coupler within the female coupler, which is in fluid communication with the supply of compressed gas. However, the rigid flange is 2 to 3 times as thick as the deflated life raft and can be uncomfortable or painful when pressed by the 40 lb SCUBA tank into the diver's back.

The diver's primary stage regulator includes 1 to 4 low-pressure (“LP”) ports supplying 100 psi compressed air or mixed gas. The low-pressure ports are used to operate the second stage of the dive regulator, inflate the dive jacket or buoyancy compensator and are used to inflate bladders at the surface or under water. Radio frequency welded polyurethane-coated nylon fabric bladders are required to sustain 8-psi pressure as tested by the USCG under UL when assessing the production of inflatable life jackets. UL listed fabrics involved in the construction of USCG Test and Approved inflatable life jackets are stiff and consequently very bulky. Current UL listed life jacket fabric is so stiff that a life raft constructed from such fabric is too bulky to carry. The use of lighter weight fabrics is required in order to produce a garment integrated life raft whose bulk is compatible with being routine worn otherwise the Personal Life Raft remains on board and unavailable to assist the Man Over Board (“MOB”) during a precipitous and unplanned water entry.

Light weight fabric compatible with being worn continually by the diver or boater, requires over pressure relief protection. In particular if the bladder is constructed from light weight fabric is designed for use at depth where rapid expansion on ascent will continue to inflate a fully inflated bladder leading to rupture during ascent.

If the diver's boat anchor lifts allowing the boat to drift away while the diver us underwater leaving the diver to drift in a coastal current for hours if not days. In an alternate scenario, the diver or buddy might panic, suffer an acute medical condition or become hypothermic or exhausted, all conditions that would benefit from a life raft which would allow the victim to able to get out of the water. The diver is only likely to be carrying a life raft if it is affordable and sufficiently compact so that it is routinely worn while diving or boating.

In the prior art as currently practiced the diver's life raft is carried until needed, between the diver and their SCUBA tank as previously disclosed. In addition to the increased cost of the three fixtures described above they also contribute all the rigid bulk, which impinges into the diver's back under the weight of the SCUBA tank. The impact of a rigid, bulky large bore OPV causes such discomfort while carrying the tank on land to the dive site that the discomfort exceeds the potential benefit and the raft is left behind.

In summary current inflatables, in particular those for use underwater as well as at the surface require 3 to 4 fitments. The first fitment the low-pressure coupler is clamped into a tube. That tube is also clamped to the one-way check valve. The check valve is then clamped into a right angle connector, which is vertically Radio Frequency/RF welded onto the bladder wall. An oral inflate valve is clamped into a second right angle connector which is also welded RF welded onto the bladder. Finally a re-enforcement flange is RF welded onto the bladder through which is mounted the large bore OPV. Together the fitments create incompressible bulk.

In addition cost is directly related to the number of operations required during manufacture. Three holes have to be cut into the fabric. Three radio frequency welded fixtures need to be assembled in the opening then welded in place before the low-pressure coupler, oral inflate deflate valve and Over Pressure Valve can be assembled and secured in position and tested.

The buoyancy compensator disclaims in writing the provision of airway protection or the expectation thereof. Also at issue is that many divers prefer the face down position during the underwater segment of the dive. While dive jackets also referred to as Buoyancy Compensators or BCs which have a large posterior buoyant moment provide reliable face down flotation during the dive as the cylinder empties the force creating airway submersion only increases. While the addition of fixed ballast or swing ballast is sufficient for some dive jacket designs to convert face down into face up positioning, certain jackets remain refractory to ballast mediated airway protection.

Thus there remains the need for a low cost, low profile single fixture to combine compressed gas and oral inflation/deflation and over pressure protection in an insert-able or in-seam welded body. The use of an interchangeable pneumatic coupler allows the same inflatable device to be connected to a 12 volt air pump, SCUBA tank, Gas station air hose, 120 volt compressor, hand pump etc. Ideally, the LP/Oral valve is combined with a small bore OPV within a single off the shelf connector or is incorporated into a RF weldable body for in-seam installation. Consolidation of fitments improves both financial accessibility and comfortable use, thereby enhancing routine compliance. Routine use of the diver's life raft will facilitate the diver's safe approach of a flailing hypoxic buddy, or confer the ability to open and stabilize a victim's airway while concurrently providing increased visibility and thermal protection during search and rescue activities. Myriad routine uses support its utility. Use of a locking connection allows the raft to remain instantly available in an emergency as a rescue approach board to a large flailing hypoxic buddy. The power inflator can be further modified to include valve regulated inflation of the diver's forward buoyant moment or PFD. Concurrently the same pressurized gas can actuate a mechanism to deflate the buoyancy compensation chamber as is required in order to achieve reliable face up flotation with certain dive jackets incorporating a large posterior buoyant moment.

A part cost is multiplied four fold by the time it reaches the consumer. The use of separate a connector requires not only purchase of another fitting but the connector requires that a hole be cut in the fabric and the connector welded to the fabric. While some valves lock closed they are currently milled from metal adding significantly to the end cost. Further locking metal oral inflate valves require that the valve be partially inserted into the connector then crimped in place. While some metal valves that lock closed few can be locked open, both require multiple steps in assembly and significant cost in parts and labor.

The use of compressed gas either from CO2 of from the Self Contained Underwater Breathing Apparatus (“SCUBA”) tank can endanger the integrity of the bladder if partially inflated orally before the power inflator is water or manually activated. Use of an OPV likewise requires another connector which requires an additional hole cut and connector welded before the OPV can be assembled or for a premium a single connector can be used but expensive connector defeats cost saving for the end user.

Both lightweight plastic valves and chrome plated brass valves rely upon a soft valve seal that upon oral inflation can be contaminated by debris from the mouth. The seal is held against the seat by a spring that has to be light enough that the survivor can easily overcome the force of the spring by expiratory pressure. Even soft debris can unseat a 1-psi spring, leading to gradual loss of air pressure with concomitant loss of bladder structure and function particularly after the cumulative effects of exposure on the survivor reduce their ability to monitor and maintain bladder pressure.

Thus given the superior performance of inflatable life saving products there remains the need to combine and eliminate valve connectors and pneumatic couplers, inflate, deflate separate from over pressure protection valves. Consolidation reduces component, assembly and final costs. A need for a single in-seam connector and pneumatic coupler with integrated inflate-deflate valve that can be cam lock closed after protecting the bladder during deployment by an inclusion of an operationally modifiable yet structurally integrated over pressure protection valve. For ease of use the valve that can be locked open for self-deflation. Such a disclosed fitment not only improves reliability and performance but also reduces component and final costs improving accessibility. Increasing access to the inflatable life preserver known for their increased comfort and compliance an important step that will contribute to a reduction in number of annual deaths by drowning.

A widely used oral inflate valve constructed with a heavy brass body is found on many life jackets and other high quality life saving inflatable products. It has a mechanism that locks the valve closed so that when bobbing about in a seaway if you bump the valve it will not open which would result in a loss of air pressure and structural integrity. Due to the high quality of the valve the inflatable device to which it is attached is almost always designed for repeated use. To deflate the attached bladder the valve has to be held open against a spring attempting to close the valve. Generally deflation requires one hand gripping the connector and a couple of fingers pulling the valve open against the tension of the internal spring. The other hand meanwhile attempts to compress the bladder against the chest to force the air out of the open valve. This is at best a slow proposition for a young person familiar with the valves operation. For an older person with some loss of use of the finger joints it can be frustrating to the point that a person with arthritis may not inflate a optional hybrid bladder early on as weather conditions worsen. Deflating a large bladder such as a raft through such a valve is aggravated by air trapping in the large bladder and the need to continuously operate the valve at the opposite end.

OPVs are not allowed on primary life saving bladders. The valve closure springs are very light compared to the valve closure springs on oral inflate-deflate valves in which the hand or head and neck supply the force to over come the spring and open the valve. The very light or low psi spring used for over pressure protection of inflatable bladders is available in 0.5-psi increments from 0.5. Depending on the bladder cracking pressures run 1.0 to 2.5 psi. The valve seat held together by such a light spring is susceptible to failure from contamination of contents often found in the mouth. A contaminated seal leads to loss of pressure and failure of the life saving device consequently over pressure valve are only found on secondary bladders and primary bladders must be constructed of such heavy fabric that they can withstand dual inflation. That is the bladder is fully inflated to 0.6 psi than the compressed gas source is actuated and the fully inflated bladder inflated a second time. Fabric capable of withstanding dual inflation is stiff and heavy which leads to increased stowed bulk and no-compliance. Sensitivity to failure of current over pressure valves eliminates the use of lightweight fabrics necessary for provision of acceptable continuously worn low profile life saving devices.

Inflatable life jackets, which have separate oral and compressed gas inflators, add considerably to the jackets cost because of the duplication in cutting and welding connectors, installing check valves and couplers. Combining the compressed gas and oral inflation valves reduces material and labor costs as well as reducing loss during manufacture and chance of failure in the field. Every radio frequency welding operation has a fixed chance of arcing and ruining the fitting, fabric possibly die, i.e. every additional connector leads to increased chance of error and wastage when welding in fitments. Every fitting that passes through a bladder increase the chance of a marginal weld not detected during testing will surface a year or two after the life jacket is fielded.

Buoyancy compensator jacket design now includes the ability to function as a life jacket when at the surface. For the large back mount bladder, which is comfortable when diving because of its aggressive face down positioning, at the surface that same strong posterior buoyant moment makes for a very poor life jacket. The redistribution of air from the back to the front of the diver converts the jacket from a face down dive jacket into a face up surface life jacket. Current connectors used are purely couplers. If there is a failure of the lightweight forward chamber the rear chamber is now longer air retentive and it would also deflates. Existing quick disconnect couplers provide for fluid communication but in the event of failure of one of the bladders, both loose air. If the existing quick disconnect is separated the male locking coupler is not a valve and the bladders contents are now in fluid communication with the environment, that is will deflate under ambient hydrostatic pressure. Ideally the forward chamber could be removed underwater and used to mark the site where the diver's buddy went missing or the entrance to a cave in which case the coupler would have to convert from fluid communication into a valve in which both bladders can be closed off. The release of a marking bladder at depth results in entrapped air expanding during ascent. While the bladder could have an additional over pressure relief valve that function could be integrated into the coupler and valve means saving cost and reducing risk of bladder failure due to redundant fittings.

The use of the current non-locking coupling is facilitated by a flange for holding the activating bridge against the spring-loaded Schrader valve. Often the other hand is in use straightening out lifelines and so it falls to a single hand to hold the non-locking valve in the on position. In the past the flange was part of a turned piece and as a single step lathe operation the flange was left round. Given that the flange is perpendicular to the long axis of the coupler when stowed, the flange is perpendicular to the plane of the stowed bladder such as a mat or raft. When carried behind the back the flange, which is often 3-5 times thicker than the stowed fabric if caught between the SCUBA tank and back of the diver is painful when carrying the tank on land. During shore dives in which the gear is carried some distance often down and up a hill the diver frequently stops and removes the bladder or attempts to move the protruding edge flange off to the side where less force is applied as the tank bounces against the diver's back.

Thus there remains a need for a valve that can be locked in the open position so that both hands can be used to roll the bladder towards the open valve to expedite deflation. The same valve should also lock closed to prevent accidental deflation. Integration of a pneumatic coupler allows for inflation by compressed gas sources or for coupling bladders together in-line as oral inflation. As an inline coupler the valve can be locked open, closed or place in an intermittent manually operated or over pressure mode of operation. The inclusion of a means to mechanically lock closed an over pressure valve allows for both the flexibility of over pressure protection of ultra-light weight fabric yet in the even to of seal contamination failure to restore and sustain bladder integrity. When used as a Valve-Coupler-OPV for an underwater bladder the no-lock pneumatic adapter has a planar grasp flange, which facilitates manually, compressed single-handed coupling. Yet the when stowed between the tank and diver's back the planar flange does not cut into the diver's back even when bearing the weight of a steel SCUBA tank.

### SUMMARY OF THE INVENTION

A life saving bladder such as life raft now includes a valve that can be locked open and pneumatically coupled to a 12-volt pump to avoid hyperventilation or long stints at the foot pump. After inflation the valve coupler is turned from the locked-open position indicated by exposed red color of the valve into the unlocked position indicated by conversion of the exposed portion of the valve to green. As the raft sits in the sun the pressure mounts and is relieved by the integrated over pressure relief valve whose operational status is indicated by the exposed of surface of the valve being green.

The raft is placed in the water, which cools the internal air lowering the pressure within the raft such that it begins to sag beneath the weight of the occupant. In the green position the valve is simply pulled open and the occupant orally inflates the raft back to structurally sound pressure. As he moves about the raft he snags the manual compressed gas inflator and the compressed gas cylinder is perforated leading to a sudden over pressurization. The excess gas is relieved by the operationally functional over pressure valve whose status is indicated by the valves green color thereby protecting the life raft from dual over inflation.

A sudden squall comes up and the inflatable raft is not able to make it back to shore. While being blown offshore the occupant notices that the raft is once again loosing pressure and structural rigidity. Inspection of the valve shows the presence of particulate matter in the valve opening that looks like the remnants of lunch. Since the cylinder was accidentally deployed already the cylinder did not need to be removed before cam locking the valve closed.

After re-inflating the raft the valve is cam locked closed operationally disabling the over pressure protection as indicated by the change in the valve color from green to red. The next morning no additional pressure losses we noted. Rescue occurred within hours of dawn. After reaching shore the valve, which had been locked closed, was opened then locked open. The weight of the fabric automatically deflates the raft while the survivor is contacting his family.

A partially inserted oral inflation-deflation valve with integrated or inter-changeable pneumatic couplers allowing inflation from multiple compressed gas sources. The valve sleeve can be pneumatically sealed to the valve body, locking it open for pressurized use inline or to expedite deflation. The valve can be locked closed to maintain pressurized bladder integrity. The combined coupler-valve may also include a continuous or intermittent use Over Pressure Relief Valve/OPV. The buoyancy compensator power inflator and dive regulator are redesigned to provide a locking or non-locking supply of compressed gas to the disclosed fixture and down stream bladder. A fully inserted and an in-seam weld-able connector-coupler-oral inflate-deflate valve-OPV adapts the multifunction pneumatic fitment to a wide range of applications. Used inline the combined fitment can provide fluid communication or over pressure transfer of gas or liquid. Planar flange allows single hand no-lock operation yet lies flat against the body. Cutting barb design allows crimp-less mounting.

Locking or non-locking low-pressure coupler-valve allows use of compressed gas to augment oral inflation of bladders. Non-locking allows the diver to quickly disconnect from an uncontrolled ascent. Bladders designed primarily for rescue at the water's surface, utilize locking low-pressure coupler/valves freeing both hands to stabilize the victim during raft inflation. The locking or non-locking termination can be integrated during fabrication of the valve inlet sleeve or assembled as a two-piece valve component before being made permanent. The combined valves reduce stowed bulk of a unique message and equipment buoys. Alternatively a range of coupling adapters can be reversibly connected to the valve inlet so that the raft can be inflated from a wider range of compressed gas sources. The dive jacket inflator is modified to include low-pressure supply for auxiliary inflatables and to allow direct inflation of a separate PFD chamber while concurrently deflating converting the dive jacket into a life jacket.

An inflatable fitment that takes advantage of the common inexpensive insert valve and introduces quarter turn friction locked deflation, quarter turn locked inflation for hands free use of integrated pneumatic coupler. An in-seam weldable body eliminates the connector and assembly operation. The over pressure valve is cam locked in or out and its operational status is clearly indicated. Classically the OPV provides protection from bladder rupture secondary to over inflation or solar expansion at the increased risk of seal failure. Cam lock closure dramatically exceeds the spring's closure force reducing or eliminating the failure previously associated with bladders relying upon multiple low psi soft seals in primary oral inflation/deflation and secondary over pressure valves.

Oral inflation valve with integrated pneumatic coupler and over pressure protection that can be locked open to facilitate deflation or locked closed to prevent deflation. Integrated pneumatic coupler allows for fluid communication, no communication or pressure relief communication with an inflation source, between chambers or to the environment. When locked closed in line it creates structurally distinct chambers, or when locked open establishes fluid communication or the valve can be adjusted to transfer gas or fluid only when above a select pressure. In event of environmental contamination of the over pressure valve seat the mechanical lock can re-establish structural independence from the environment or connected chamber. A range of permanent or inter-changeable locking and non-locking pneumatic couplers allows attachment to various compressed gas sources. Barb design allows crimp-less mounting of a partially external Valve-OPV-Coupler. Low profile planar flange allows single handed use of no-lock coupler yet stows comfortably adjacent the body.

Upon arriving at the dive site the threaded pneumatic coupler of the raft's inflation valve allows connection to a 12-volt car pump. The Valve-Coupler-OPV is placed in the locked open position and the raft fills over a period of several minutes. Then the raft is disconnected and the Valve-Coupler-OPV is now converted to the locked closed position. Before entering the water the diver exchanges the pneumatic coupler for a locking 100-psi SCUBA coupler. After being in cold water the raft begins to soften and the low-pressure hose from the dive cylinder is connected and the raft re-inflated to full structural pressure. Latter that after noon the raft is dragged onto the hot sand and in the sun the pressure rises until the Valve-Coupler-OPV's over pressure relief point is exceeded and excess gas vents protecting the raft from rupture. When ready to leave the valve is locked open and the raft is rolled up with both hands available to assure that no air in entrapped. As the raft is tightly rolled up the expressed air is passed out the locked open valve.

While diving the diver uses a locking pneumatic coupler to connect the forward chamber to the rear chamber. At the surface half way through the dive the diver releases the forward chamber cover and the in line valve-coupler which is locked in the open position allowing fluid communication between the front and rear chambers and air flows forward. As the buoyancy is moved from behind the diver to in front, the face down surface position is converted into a face up surface position. At the end of the surface interval the diver leans forward and the air returns to the rear chamber and the front chamber deflates by hydrostatic pressure and is easily folded and stowed. At depth the diver's buddy becomes ensnared in a commercial steel dragline and the hooks puncture his wet suit in several places as well as his forward chamber. The dive buddy resets the in-line valve coupler to the locked closed position, isolating the rear chamber from air loss previously associated with the punctured forward chamber. The first diver wishing to request assistance from the crew above uncouples his forward chamber from the rear chamber and converts the valve-coupler-OPV into the intermittent over pressure relief mode of operation. He attaches a note requesting assistance and inflates the forward chamber from his low-pressure air hose. As the forward chamber/surface marker ascends the volume inside the bladder doubles by expansion but the excess gas is past out of the over pressure valve protecting the rapidly ascending bladder from rupture.

It is the primary object of this invention to provide a plastic valve that can be inserted within a connector that can be locked in a self-deflating open position.

It is the additional object of this invention to provide a plastic valve that can be inserted within a connector that can be locked in open position for continuous hand free inflation.

It is the object of this invention to provide a plastic valve that can be inserted within a connector that can be placed in a over pressure protection.

It is the object of this invention to provide a plastic valve that can be inserted within a connector that can be removed from over pressure protection.

It is the object of this invention to provide a plastic valve that can be inserted within a connector that can be cam locked under high pressure to achieve improved seal closure in a contaminated environment.

It is the object of this invention to provide a plastic valve that can be inserted within a connector whose valve sleeve can provide non-locking pneumatic coupling.

It is the object of this invention to provide a plastic valve that can be inserted within a connector whose valve sleeve can provide locking pneumatic coupling.

It is the object of this invention to provide a plastic valve that can be inserted within a connector whose valve sleeve can provide threaded pneumatic coupling.

It is the object of this invention to provide a plastic valve that can be inserted within a connector whose valve sleeve can provide compression sealed pneumatic coupling.

It is the object of this invention to provide a plastic valve that can be inserted within a connector whose valve sleeve can provide oral pneumatic coupling.

It is the object of this invention to provide a plastic valve that can be inserted within a connector whose valve sleeve can provide oral and locking, oral and non-locking, oral and threaded, oral and compression sealed pneumatic coupling.

It is the object of this invention to provide a plastic valve that can be securely inserted within a connector with bi-directional sharp barbs.

It is the object of this invention to provide a plastic valve that can be embedded within a weldable flange.

It is the object of this invention to provide a plastic valve body that can be made from weldable plastic.

It is the object of this invention to provide a plastic inflate and deflate valve with side by side over pressure relief valve that can both be made from weldable plastic.

It is another object of the invention to provide a multifunction valve that can be locked open to deflate or to provide fluid communication when coupled to another bladder.

It is an additional object of the invention to allow a Valve-Coupler-OPV with integrated coupler to be locked closed when attached to a single bladder or when coupled in line.

It is a further object of the invention to allow the combined valve and coupler to be used intermittently by mechanically opening the valve when used separately or when used inline as a coupled valve.

It is a further object of the invention to integrated an over pressure relief valve to regulate and direct flow when part of a coupled application or out into the environment when used separately.

An additional object of the invention is a ridge locking quarter turn adapter to meet the specific demands of the forces applied to the Valve-Coupler-OPV, attached fabric, connector and user strength and age. It is a further object of the invention to provide a sharp cutting barb non-removable valve-Coupler-OPV for crimp-less attachment to the connector.

Some advantages, include, but are not limited to: (a) Locking open, normally closed valve; (b) Locking open, normally closed intermittent valve; (c) Locking open, normally closed oral inflate deflate valve; (d) Locking open, Locking closed, normally closed valve; (e) Locking open, Locking closed, normally closed valve, intermittent valve; (f) Locking open, Locking closed, normally closed oral inflate deflate valve; (g) Locking open, normally closed valve with interchangeable couplers; (h) Locking open, normally closed valve with integrated valve sleeve-coupler; (i) Locking open, normally closed valve with integrated single piece valve sleeve-coupler; (j) Locking open, normally closed valve with integrated two piece valve sleeve-with interchangeable couplers; (k) Locking open, normally closed valve with integrated two-piece valve sleeve-with permanently attached coupler; (l) Locking open, normally closed valve with integrated locking coupler; (m) Locking open, normally closed valve with non-locking coupler; (n) Locking open, normally closed valve with threaded coupler; (o) Locking open, normally closed valve with compression coupler; (p) Locking open, normally closed valve with combined coupling means; (q) Locking open, normally closed over pressure relief valve; (r) Locking open, locking closed, normally closed over pressure relief valve; (s) Locking open, locking closed, normally closed over pressure relief valve with interchangeable couplers; (t) Locking open, locking closed, normally closed over pressure relief valve with integrated coupler single piece, two piece, locking, non-locking, threaded, compression or combined; (u) Above valves with non-removable cutting barbed attachment means; (v) Thermally ductile connector tubing and fitment soften to facilitate permanent connection; (w) Complementary reverse barbed connectors and fitments; (x) Crimp-less mounted external valve; (y) Keyed locking sleeve; (z) Keyed locking sleeve triple function locked open position, locked closed position, normally spring closed intermittently open position; (aa) Keyed locking sleeve directs insertion of male key; (ab) Keyed locking sleeve receives key as it tightens; (ac) Keyed locking sleeve rejects key as it loosens; (ad) Opposite key passage obstructed; (ae) Key retainer size restricted to size of key; (af) Key position indicator on exposed valve sleeve; and (ag) Above valves with planar grasp flange.

### BRIEF DESCRIPTION OF DRAWINGS

FIG. 1 is a lateral view illustrating a valve that can be inflated orally or by coupling to a range of low-pressure pneumatic supplies. The valve sleeve can be manufactured to combine oral, locking or non-locking compressed gas inflation into a single piece. Alternatively an adapter can be glued to existing oral valve sleeve. For certain applications a range of diverse pneumatic adapters can be reversibly attached to same valve to allow multiple air sources to be used for inflation.

FIG. 2 is a lateral view illustrating a BC power inflator valve modified to include a non-locking female pneumatic coupler allowing safe inflation of locking or non-locking male adapters attached to a diverse range of bladders in the pressurized environment that occurs at depth.

FIG. 3 is a lateral view illustrating a locking female pneumatic coupler providing a low-pressure supply for inflation of a life raft while the divers has both hands free to assist establish a victim's airway. Upon full inflation of the life raft excess air in safely vented through and overpressure valve until the rescuer is able to free a hand to disconnect the life raft.

FIG. 4 is a lateral view illustrating a pressurized message board and equipment float tailored to the reversible connectors specific to the diver's dive jacket. Routine messages are posted on a smaller inflatable drum. While need for emergency assistance is announced with a large flat surface preprinted with the international SOS request for immediate assistance. For routine purposes the float can be inverted providing a wide range of flotation bladders to support and mark the location of equipment at the surface. The dedicated buoy bladder can be varied to match the load to assure that the message board is upright and stable at the surface. An integrated over pressure valve and lanyard allows use at depth for salvage or bottom marking.

FIG. 5 is a lateral view illustrating a range of applications for the combined compressed gas/oral inflation of dive markers, equipment buoys, message boards, game bags, weight belt floats. Yet by the consolidation of the oral inflation/deflation valve and over pressure valve eliminates considerable cost in materials labor and parts while reducing bulk and providing increased concurrent safety features.

FIG. 6 is a lateral view illustrating a quick release pneumatic block that can be placed in line with fielded dive jacket to provide locking and non-locking supplies of pressurized air for convenience, comfort and improved safety.

FIG. 7 is a lateral view of a series of BC power inflators sequentially modified a range of improved features built in during construction of the power inflator. Advantages range from non-locking power supply for safe inflation at depth to locking inflation of rafts to optional valve operated inflation of a PFD bladder to integrated PFD design in which the BC will not work if the PFD bladder is not attached. Some BC require deflation in order to allow corrective rotation to occur this can be accomplished manually or through the use of pneumatic pressure to deflate the rear chamber.

FIG. 8 is a BC power inflator in which the hose used to deflate the BC while inflating the PFD is hidden within the power inflator hose. The pressurized gas interfaces with the over pressure valve to facilitate deflation of the rear chamber while the life jacket is inflating.

FIG. 9 is a lateral view illustrating, insert-able valve with a range of combined pneumatic coupler valve inlet sleeves. The upper valve is a locking-deflate locking-inflate with a no-lock pneumatic coupler allowing safe use underwater by a diver trained in salvage. The lower drawing illustrates a locking-deflate insert-able valve with a locking pneumatic coupler, which can be safe use at the surface or on land.

E.g. when the valve is locked into the open position it allows hands free inflation of a life raft a diver's tank while attending to a distressed victim. A tire valve adapter adapts the bladder to a 12-volt tire pump.

FIG. 10 is a lateral view illustrating a choice of pneumatic coupler inlet sleeves as part of a locking inflate and locking deflate insert valve. The top valve is an oral and non-locking pneumatic coupler. The middle valve is an oral and locking pneumatic coupler. The lower drawing is of an oral and threaded/compressible pneumatic coupler.

FIG. 11 is a lateral view illustrating in seam welded valves. The top valve is a locking inflate and locking deflate oral valve with non-locking pneumatic coupler in which the non-weldable valve body embedded in weldable flange. The middle drawing is of an in-seam over pressure valve/OPV in which the valve body is built into the flange and they both made from weldable plastic in a single step. The lower drawing is of a locking inflate-deflate valve in which the pin turns into a large cavity and the valve is held open by a valve body ledge and an O-Ring seals the sleeve.

FIG. 12 is a lateral view illustrating a pair of over pressure valves combined with locking-inflate locking-deflate valves. In the top drawing a single insert-able valve combines the OPV and inflate-deflate valves in line. A color coded quarter turn locking sleeve allows the over pressure relief function to be operational or locked out. It also allows the valve to lock open for ease of deflation or locked closed to prevent inadvertent loss of pneumatic pressure while asleep of lethargic. The lower valve is an inline side-by-side valve with the inflate-deflate valve and over pressure valve built into the same weldable body eliminating the cost and installation of a connector.

FIG. 13 is a superior and lateral view of a cam quarter turn pin built into a valve sleeve. As the sleeve is rotated generates increasing pressure on a contiguous valve seal. Alternatively the cam can be built into the top or bottom of the valve body where its action on a straight quarter turn pin of a stepped valve sleeve can then be used to compress seals in either direction.

FIG. 14 is a lateral view illustrating the normally spring closed intermittent configuration, locked closed and locked open configurations of the oral inflate-deflate valve with locking pneumatic coupler. A key on the valve sleeve engages with the variable position outer sleeve that allows intermittent, open or closed operation of the valve-coupler. Cutting barbs eliminate the need for a crimp band on this partially external valve-coupler.

FIG. 15 is a lateral view illustrating a range of pneumatic or hydraulic couplers that can be formed as a single piece during manufacture or a coupler end can be ultrasonically welded to a universal base forming a valve-coupler sleeve assembly. Alternatively a range of adapters can be reversibly mounted on a universal base. A planar grasp flange allows single hand use yet stores comfortably against the body. The outer sleeve entraps, compresses or disengages from the valve sleeve key establishing the valve operation as locked open, locked closed or intermittent use.

FIG. 16 is a lateral view illustrating the inline use of a quarter turn locking pneumatic coupler with an open, closed or intermittent over pressure valve. The use of an inline integrated over pressure valve in the intermittent mode is also illustrated. The uncoupled over pressure valve can be used to vent directly to the environment. If contaminated the mechanical lock can re-establish a functional seal.

FIG. 17 is a superior view illustrating the inclusion of a locking or non-locking pneumatic coupler in the low-pressure hose dive regulator. The back up regulator or octopus is mounted on an over sized 100 psi hose so it can be handed off to a buddy underwater. That same length facilitates inflation of underwater markers or life rafts at the surface.

### DESCRIPTION OF THE PREFERRED EMBODIMENT

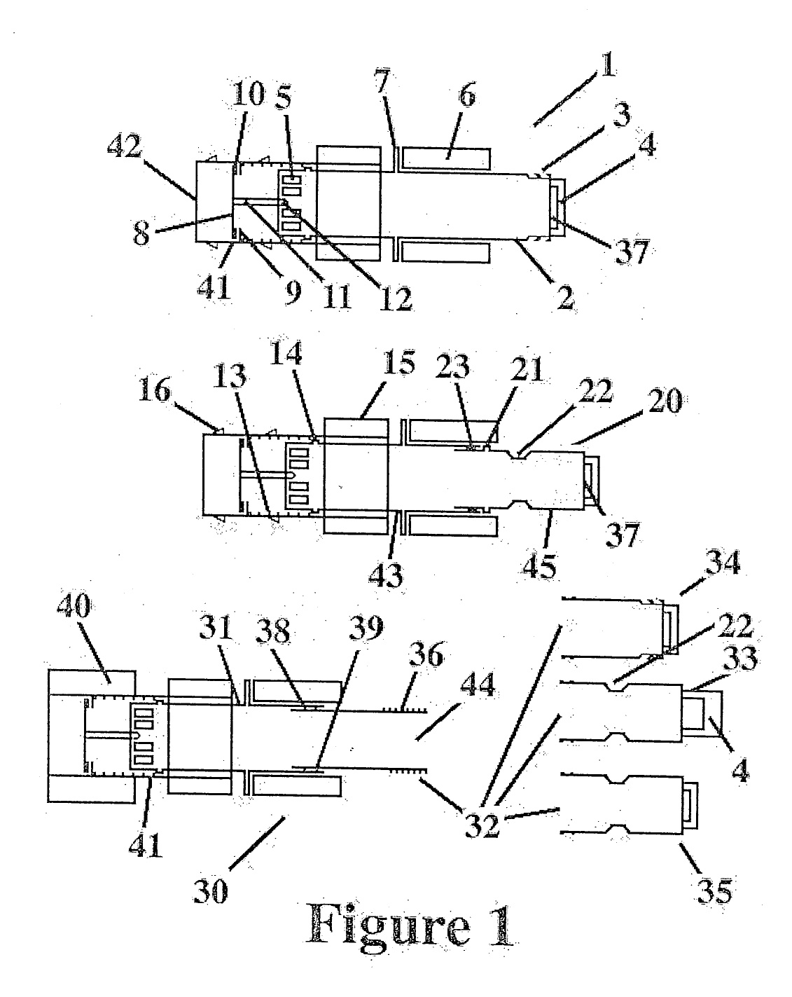

The upper drawing of FIG. 1 is a cross sectional view of a combined low-pressure coupler and oral inflation and deflation valve 1. The valve sleeve 2 is of single piece construction with valve sleeve inlet 37 bridged by actuating arch 4 which compresses complementary compressed gas supply valve. Valve sleeve 2 has a stop 7 which blocks rearward movement of the soft lip cover 6 and in addition stop 7 limits the rearward movement of valve sleeve 2 by abutting against valve lock 15 threaded to valve body 41. Valve sleeve 2 is perforated by valve sleeve outlet 5 allowing passage or breath or compressed gas from valve sleeve inlet 37 to valve outlet 42. Valve sleeve 2 has a ridge 14 that acts as a stop for valve spring 13. Valve face 8 is connected to valve sleeve 2 via valve post 11. Valve face 8 and sleeve 2 are secured together by friction lock 12. Valve face 8 compresses valve seal 10 against valve seat 9 by the force generated by valve spring 13. Valve spring 13 is held in a compressed state between valve sleeve spring stop 14 and valve seat and spring stop 9. When external pressure is applied to valve sleeve 2, spring 13 is further compressed as the force that is applied to valve sleeve 2 is transferred through post 11 to move valve face 8 and seal 10 away from seat 9 thereby allowing air to pass from valve sleeve inlet 37 through valve outlet 42 into attached fitting, tubing or directly into bladder. Valve barbs 16 secure combined oral-compressed gas valve within tubing or fitting. Single piece valve sleeve 2 is of no-lock design, which will not receive locking means located in complementary female pneumatic coupler. Alternatively single piece valve sleeve 2 could be manufactured with locking groove shown in the middle drawing in FIG. 1. Further the outer surface of single piece valve sleeve 2 can be textured, scored, threaded indicated at 3 to increase purchase by certain compressing pneumatic female coupling devices.

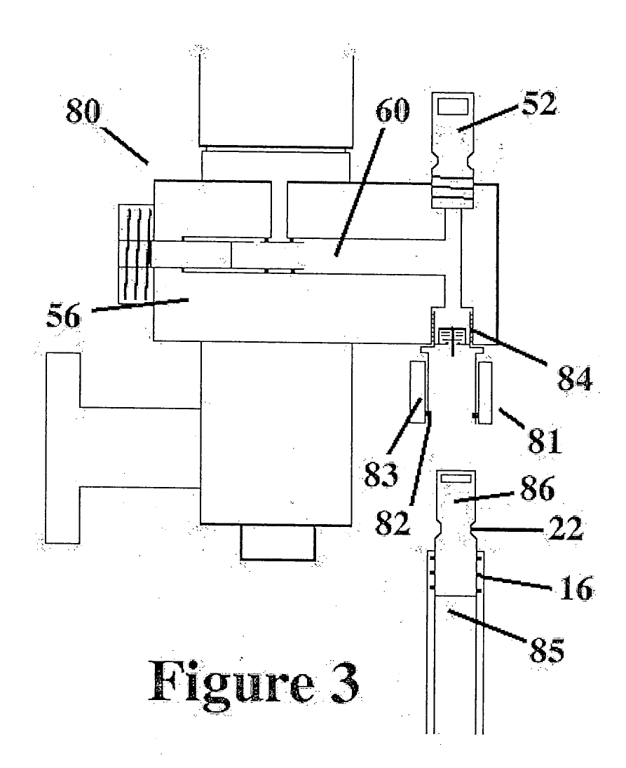

In the middle drawing of FIG. 1 a two part construction 20 of the valve sleeve involves a glued or ultra-sonically welded joint 23 between an inner 43 and outer halves 45. As part of a two-step manufacture or in field retrofit, adapter stop 21 limits the depth that low-pressure adapter extension 20 can be inserted within the inner portion of valve sleeve 43. Ultra sonic weld or adhesive 23 permanently bonds outer sleeve low-pressure adapter 45 to valve sleeve 43. The particular pneumatic adapter extension shown in the middle drawing of FIG. 1 includes locking grooves 22. In FIG. 3 spring loaded sleeve 83 pushed balls 82 into groove 22 of outer half of valve sleeve 45 as seen in FIG. 1. Generically a locking pneumatic coupler is shown in the lower drawing of FIG. 1 as pneumatic adapter 35.

In the lower drawing of FIG. 1 a two-part oral low-pressure inflator-deflator valve 30. A universal receiver valve sleeve 31 reversibly mounts a range of pneumatic couplers. Depicted is a selection of quarter turn sleeve extension adapters 32. An alternate no-lock adapter design 33 extends bridge 4 away from the locking grooves 22. The extended bridge of adapter 33 keeps the oral-pneumatic valve from being able to engage the locking means of the female pneumatic coupler. Adapter 34 is a previously disclosed no-lock design that lacks the grooves 22 so that it must be held within the female pneumatic coupler during operation. Adapter 35 is a locking adapter allowing the attached item to remain secured to the operator until released. An externally threaded adapter 36 allows the valve to attach to complementary pneumatic couplers. Inlet orifice on adapter 36 lacks the centerline bridge seen on other adapters. Open inlet orifice 44 allows certain female couplers with actuating rods to protrude through orifice 44 into the two-part valve sleeve while the exterior threads 36 supply a textured surface to be grasped by pneumatic couplers that compress about the male adapter 32. In the lower drawing the valve body 41 is encased in flared weldable plastic flange 40 creating a single fixture integrating: oral inflator, manual deflator, pneumatic coupler and weldable bladder connector. The weldable flange 40 of valve 30 is tapered to allow in-seam hermetic seal with a similarly coated fabric laminate bladder.

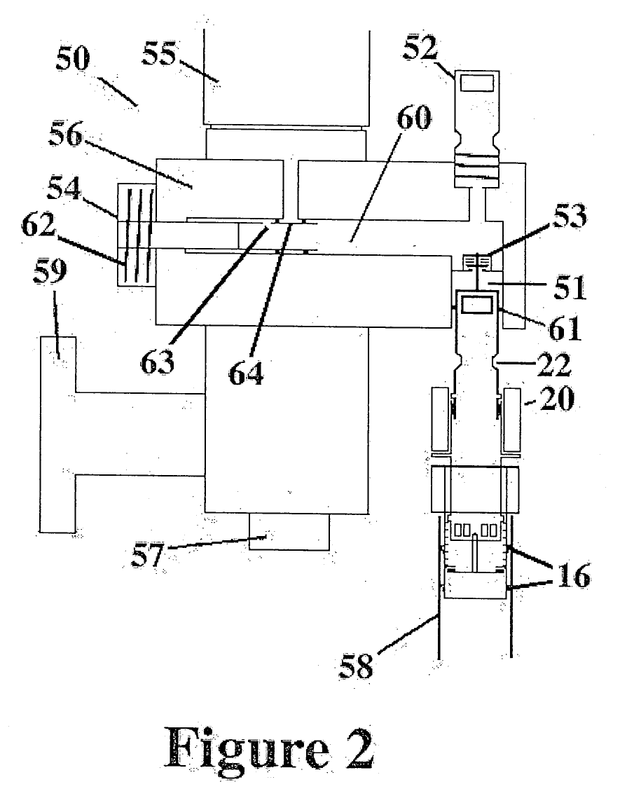

FIG. 2 is a cross section of a buoyancy compensator power inflator valve body 56 including a no-lock female pneumatic coupler 51. An air supply from the primary stage regulator, which is attached at the dive tank, connects to the locking male adapter 52. There is fluid communication 60 in the central chamber of the power inflator valve body 56, which continuously supplies gas to the no-lock female coupler 51. The push to open valve 53 within the no-lock female coupler 51 receives a locking 22 two-piece oral and pneumatic valve 20. The oral-pneumatic valve 20 is manually held in position and pneumatically sealed to the no lock coupler 51 with O-Ring 61. The continuously pressurized chamber 60 also supplies pressurized gas to the normally closed valve 54. Valve 54 is held in the closed position by spring 62. Upon manually depressing valve 54 the normally closed portion 64 slides out of the way and orifice 63 allows air passage, as long a valve 54 is held open. Pressurized gas passes through 63 into and through wide bore conduit 55 then directly into the attached dive jacket bladder. Conduit 55 is wide bore to reduce the resistance to flow during very low-pressure oral inflation. To orally inflate the dive jacket button 57 is held depressed while the diver blows through mouthpiece 59.

FIG. 3 is a buoyancy compensator power inflator with locking low-pressure supply 80, which is in continuous fluid communication through chamber 60 with the supply line attached to locking male pneumatic coupler 52, which is threaded into inflator valve body 56. The locking female coupler 81 is threaded 84 into the power inflator valve body 56. The locking female coupler 81 is comprised of a spring-loaded slide 83 that forces a circumferential series of balls 82 into the groove 22 of the barbed locking male adapter 86. Once locked in place, tubing 85 and attached bladder, is placed in fluid communication with the compressed gas from the primary stage regulator, which is attached to the buoyancy compensator power valve body 56 at threaded locking male coupler 52.

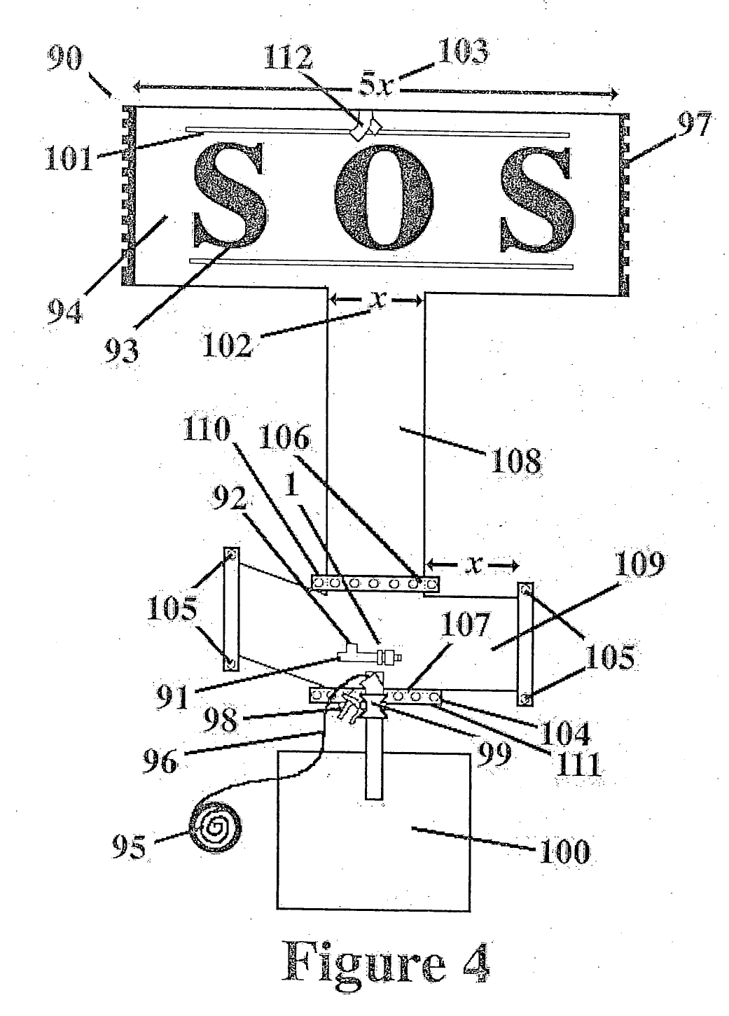

FIG. 4 is a variable displacement equipment marking buoy supporting routine or emergency messages 90. A single Radio Frequency weldable connector 92 combines the oral and pneumatic inflate/deflate valve 1 and over pressure valve 91. A universal request for immediate assistance, SOS 93 on non-traditional high visibility color 94 faces out when assembled in the illustrated emergency configuration. Release of zipper 97 increases the size of the message board by 100% for increased visibility. Diagonal through weld 101 reduces ballooning of message board. A large SOS is displayed though other messages, such as, but not limited to, HELP, DIVER, etc. can also be displayed and are also within the scope of the invention.

In FIG. 4 construction of the signal equipment buoy 90 relies upon selecting a unit size X 102. The indicated unit of measure is the width of the deflated staff deflated 108. The overall width of an emergency SOS signal can be about 5X 103, though other ratios can be used and are considered within the scope of the invention. The variable displacement buoy chamber 109 varies from about x to about 3X in size, though other dimension can be used and are considered within the scope of the invention. Construction relying upon integral units of width 102 facilitates compact folding and minimal irregularity in stored bulk.

In FIG. 4 the equipment buoy 109 is mated with a complementary quick release buckle 98 to quickly and securely attach a range of pockets and equipment. Illustrated is detachable buoyancy compensator pocket 100 secured to equipment buoy and message marker 90. Incorporation of over pressure valve 91 in bladder 90 allows it to be used at depth for salvage or bottom marking. Line spool 95 feeds out lanyard 96 as the signal ascends to inform surface crew.

In FIG. 4 the amount of displacement is matched to the amount of attached ballast by selecting appropriate position to fasten reversible connectors 104. Fasteners 105 at the edge of the buoy 109 can be variably attached along superior attachment strip 110. Strip of fastening means 110 is attached at the edge of inflatable staff 108 by permanent attachment means 106. The inferior variable attachment strip 111 is permanently attached at 107 along the bottom edge of the buoy bladder 109.

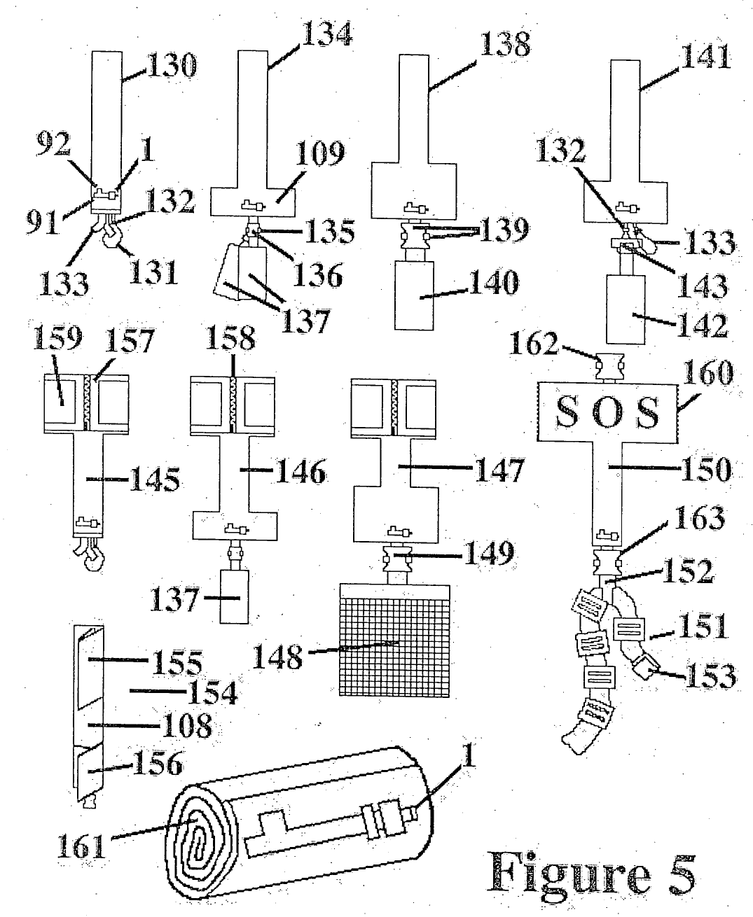

In FIG. 5 the combined compressed gas coupler and oral inflate valve 1 is joined with and over pressure relief valve 91 and attached through a single weld 92 to a fixed displacement marker 130. Marker 130 includes strap 133 for attaching a wide range of buckles for securing varied dive equipment. Loop 131 can be secured about T-handle 143 pocket weights by sliding friction lock 132 in position. Medium displacement marker 134 includes enlarged bladder 109 to support additional integrated ballast pockets 137. The marker 134 is dedicated to the particular dive jacket. Many dive jacket integrated weight systems have unique securing means. Indicated in FIG. 5 weight pockets 137 have quick release female buckles 136 initially used to secure pocket 137 to the dive jacket. Equipment buoy 134 has complementary male buckle 135 allowing pocket 137 to be quickly and securely transferred to equipment buoy 134. A high displacement equipment buoy 138 is dedicated to a different quick release buckle 139. The equipment buoy 138 is sized for the cold water diver's heavier integrated weight pockets 140. Equipment buoy 141 is dedicated to yet another dive jacket design that relies upon T-handle 143 weight pockets 142.

In the second row of FIG. 5 the marker and equipment buoy 145 is combined with a white message board 159 on a traditional red-orange colored fabric 157. The medium displacement marker 146 has the routine message board zipped closed 158 with attached warm water integrated weight pocket 137. The high displacement message buoy 147 is supporting a mesh game bag 148 secured to message buoy 147 by quick release buckle 149 compatible with cold water integral weight pocket buckles 139 viewed directly above attached to buoy 138.

In FIG. 5 an multi-function signal float 150 includes emergency-SOS marker, writing tablet and locator staff with a high displacement float. In the far right drawing of the middle row of, the weight belt 151 orients the unfolded SOS flag 160. The diver releases weight belt buckle 153 then attaches weight belt 151 through belt mounted buckle 152 to buckle 163 where the weight is used to orient the Distress marker. In routine diving the weight is attached to buckle 162 at the opposite end of float 150 which submerges the large bladder so that the distress signal is no longer held aloft.

The bottom row of drawings in FIG. 5 demonstrates folding 154 the triple message buoy 150. The folded message bladder 155 and folded equipment buoy 156 is aligned over the staff 108. Then the deflated and folded message buoy is tightly rolled 161 with the oral-compressed gas coupler 1 readily available.

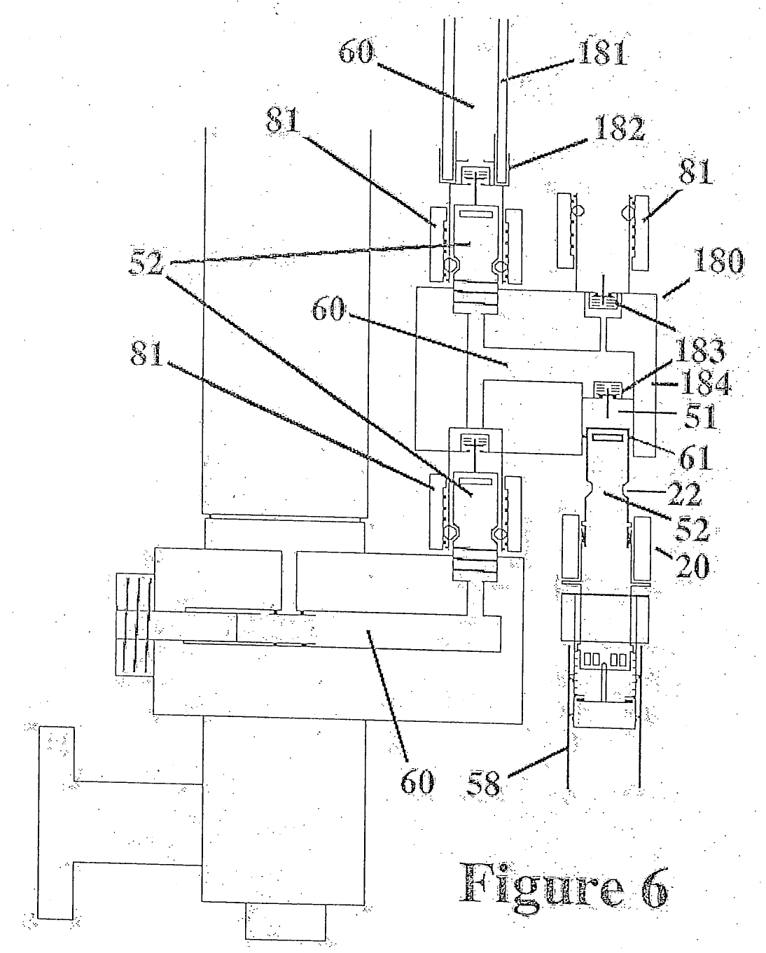

In FIG. 6 an existing power inflator has a pair of low pressure ports interposed between the 100 psi air supply line 181 which is crimped by ferrule 182 on to locking female pneumatic coupler 81 and the power inflator valve body 56. The low-pressure supply valve block 184 has a threaded locking male adapter 52 to secure the low-pressure supply line 181. A common chamber in fluid communication 60 connects the 100-psi supply to the power inflator through inferior locking female pneumatic coupler 81. Pressurized chamber 60 supplies air to superior locking female pneumatic coupler used to attach inflatable bladders such as life raft. On the inferior surface a no-lock female pneumatic coupler 51 is operational only along as the diver presses male adapter 52 against the normally closed valve 183. The no-locking female pneumatic valve 51 can be safely used under water with locking or non-locking male pneumatic connectors. Upon release either male connector falls away from the diver. The locking male coupler 52 and non-locking female coupler are sealed by O-Ring 61.

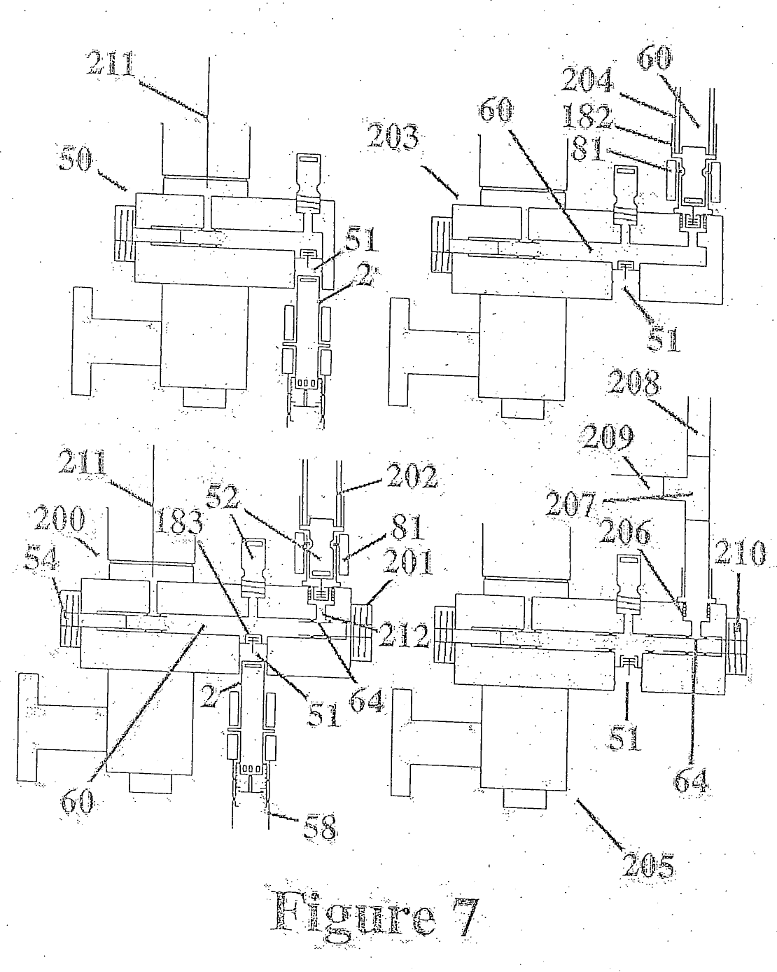

FIG. 7 demonstrates a buoyancy compensator power inflator with an auxiliary low-pressure supply port 50. Specifically a no-lock female pneumatic coupler 51 into which is being inserted a combined no-lock male pneumatic coupler and oral inflation valve 2 for safe inflation of bladders in a pressurized environment. A standard feature of power inflator assemblies is a cable 211 that leads to a manual deflation valve mounted on the bladder of the dive jacket.

The second power inflator in the top row of FIG. 7 is a power inflator with dual low-pressure supply ports. A no-lock female port 51 and a locking female pneumatic coupler 81 are shown. A tube 204 held by ferrule 182 to female coupler 81 is in fluid communication 60 with the central chamber within the power inflator body also indicated as 60 to express their continuous communication.

The left had drawing on the lower row of FIG. 7 discloses a power inflator with a manually actuated normally closed valve 201 for optional incorporation of an inflatable life jacket. Buoyancy compensator inflator 200 also includes a non-locking female pneumatic coupler 51 about to inflate a life raft attached to tubing 58 after non-locking male adapter 2 depresses and opens normally closed valve 183. While the buoyancy compensator is inflated by depressing 54, depressing 210 moves the normally closed valve element 64 away from the orifice 112 allowing pressurized gas to pass through the female pneumatic coupler 81 held open by locking male adapter 52 and into the tube 202 thereby inflating the life jacket chamber. Some buoyancy compensator bladder designs require the rear chamber to be deflated in order to allow corrective turning. As the operator depresses valve 201 they pull down on the valve body 56 that pulls cable 211 thereby concurrently deflate the buoyancy compensation chamber.

The lower right had drawing of FIG. 7 discloses a BC power inflator in which the PFD is integral to the BC design. In that if the thread connector 206 is not connected the BC will not hold air. The depression of valve 210 supplies pneumatic force to tube 209 to inflate the PFD and to tube 208 to deflate the BC. The resultant dramatic shift in buoyant forces leads to airway protective corrective rotation.

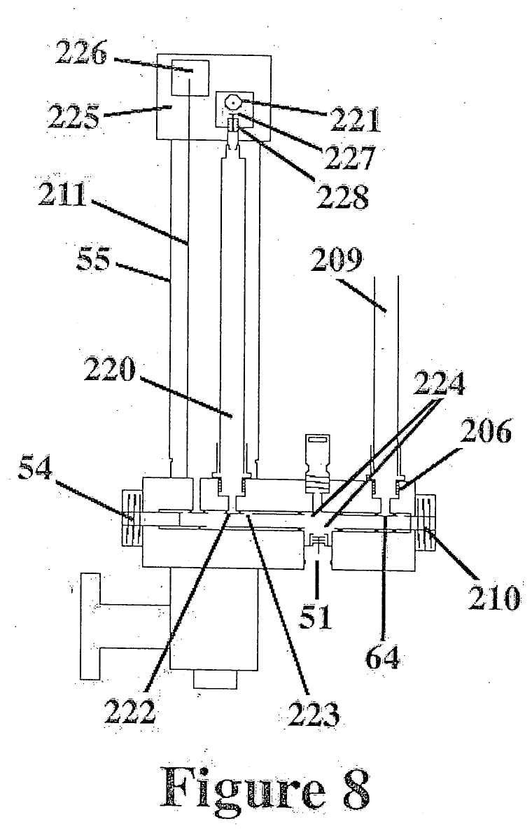

FIG. 8 details the use of an internal tube 220 to activate deflation valve 228 via pressurizing pneumatic ram 227 to assist spring biased over pressure valve 221, rather than having to pull down inflator lanyard 211 to activate manual deflation valve 226 simultaneously with depressing PFD inflation button 210. In FIG. 8 as PFD button 210 is depressed seal 64 is moved out of the way and compressed gas is supplied for PFD inflation via tube 209. Simultaneously seal 222 is moved away from tube 220 and orifice 223 is moved transiently into position allowing pneumatic pressure via tube 220 to activate ram 227 to assist over pressure valve 221 to rapidly deflate BC.

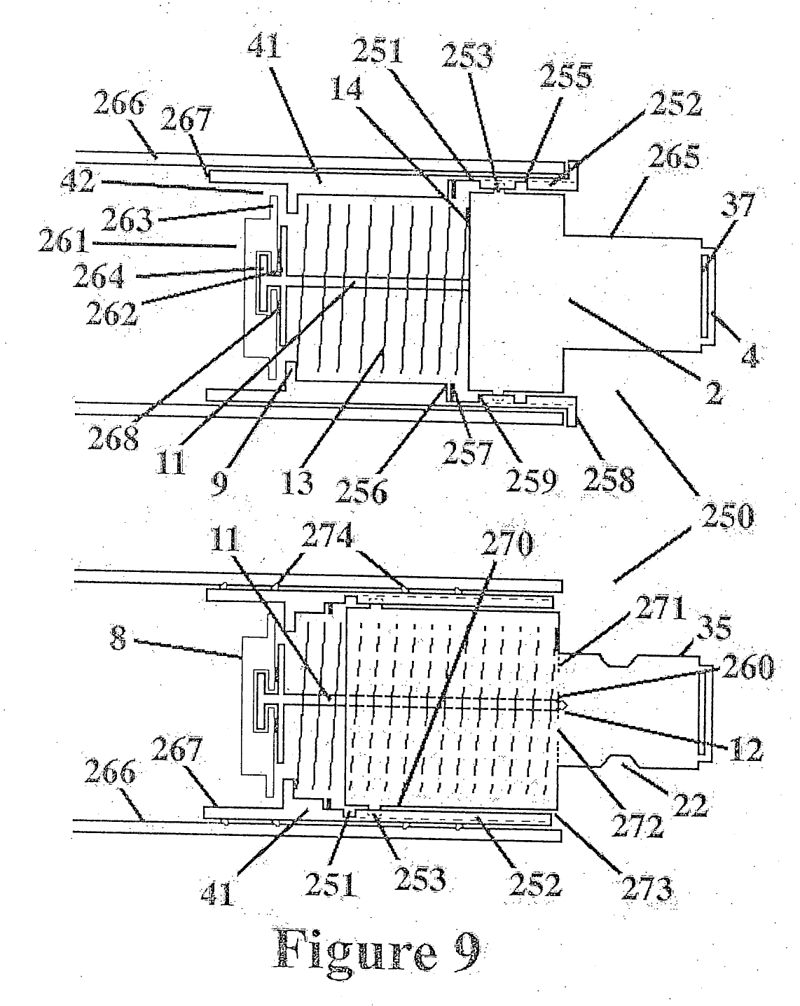

The top drawing in FIG. 9 is of a normally closed locking-inflate and locking-deflate insert valve 250. Inserted with tubing 266 insert valve 267 is valve body 41, a single piece oral and compressed gas coupler valve sleeve 2 and a valve face seal and outlet assembly 261 connected by a valve post 11. Valve spring 13 stops against the protuberance of the valve body 41 that serves as the valve seat and spring stop 9. The other end of the valve spring 13 mounts on valve spring stop 14 of the valve sleeve 2. This assembly keeps the valve on a normally closed position under the force of spring 13 until prevailing force is applied to valve sleeve 2. If a supply of air terminated by a Schrader valve is slipped over a no-lock adapter valve sleeve 265 the Stirred bridge 4 engages low-pressure air supply valve allowing air to pass through valve inlet orifice 37 through the valve sleeve to the valve outlet 42 by passing through the valve body 41-valve core outlet face and seal 263. The compressible valve face and seal is attached to the valve seal mechanical mount 264 and is held against valve core outlet mounting plate 262. An adhesive between valve core outlet to valve seal 268 further secures the valve face and seal 263 to the valve core outlet mounting plate 262.

In FIG. 9 a source of compressed gas is actuated by Schrader bridge 4 of the valve sleeve 2 the sleeve is pressed against a cam compressible seal between inlet adapter and valve body 257 mounted on valve body stop 256 so that the pressurized gas flows in the direction of least resistance through valve outlet 42 into tube 266 then onto an attached end use or bladder. The valve sleeve includes a quarter turn pin 253 that travels up and down longitudinal quarter turn pin track 252. When the pin 253 of valve sleeve 2 is turned into the inner quarter-turn groove in body of valve 251 it holds the valve outlet 42 open so that the down stream structure is in fluid communication with the inlet orifice. If the inlet orifice 37 is at ambient pressure then the valve is in a locked deflate position. When the pin 253 of valve sleeve 2 is turned into the outer quarter-turn groove in body of valve 253 the seal 263 is compressed against the valve body face 9 and the valve is locked shut. The insert-able valve 267 is prevented from over insertion by insert depth stop 258 that abuts against the end of tube 266.

In the lower drawing of FIG. 9 the valve body 41 is held into tube 266 by bi-directional cutting edged barbs 274 which oppose valve dislocation once insert-able valve 267 is inserted tube 266 softened by heat. An extended length valve sleeve adapter 270 and a reduced lateral deflection gap 273 between valve sleeve 270 and valve body 41 produces a tighter valve. The valve face normally spring closed 8 is attached by post 11 to locking adapter 35 by a compression lock 260. This secure valve face to valve sleeve connection 12 occurs in the middle of grid 271 which mounts compression lock 260 surrounded by fenestrations 272 that allows compressed gas to pass through the valve. When valve sleeve pin 253 is turned into the inner quarter turn groove in body of valve 251 the valve is locked open and then the locking grooves 22 of locking adapter 35 can mount a source of compressed gas to inflate a large structure such as a raft without having to continuously hold the valve open.

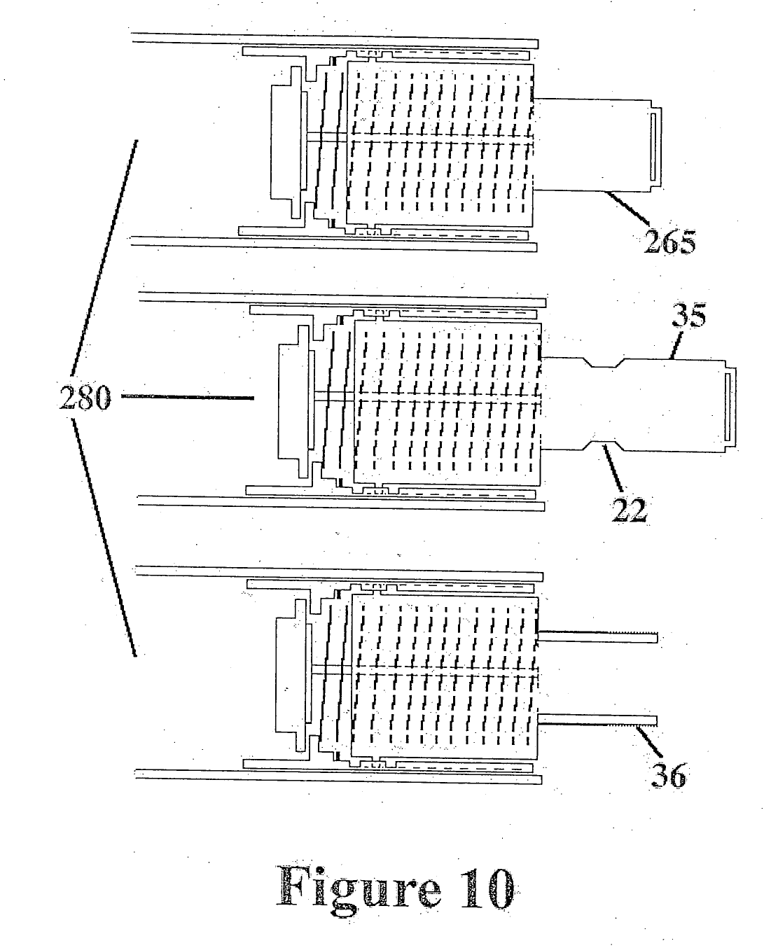

FIG. 10 demonstrates a series of three different valve sleeve adapters 280, each of which can be orally inflated or inflated by use of the pneumatic coupler. The top drawing is of a valve that can be orally inflated or inflated by holding the no-lock adapter valve sleeve 265 against a Schrader valve. If the user lets go of the valve the compressed gas source automatically disconnects, a safety feature for use underwater. The second locking open or closed insert valve has a locking pneumatic coupler 35 as identified by the locking grooves 22. The third valve integrated a valve stem threaded adapter 36 into a locking open or closed insert valve 280.

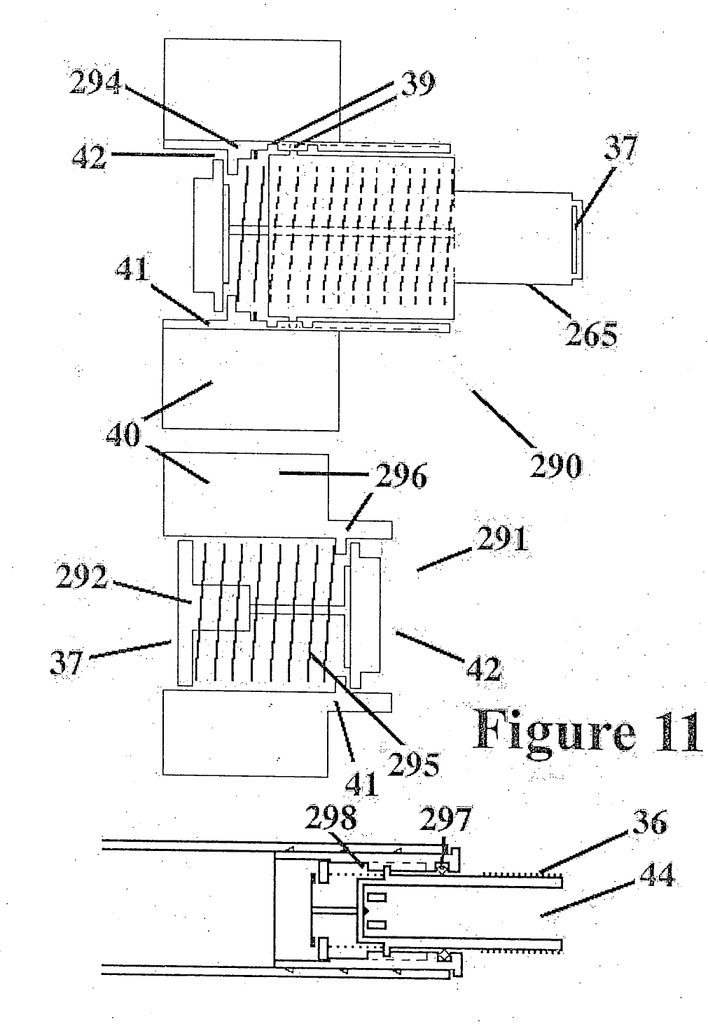

FIG. 11 a weldable flange embedding combined connector-coupler with locking inflate locking deflate valve 290 allows in seam welding avoiding need for a connector fitting. The valve body 41 is embedded 294 in a weldable flange 40. Locking quarter turn means 39 allows the valve to be locked open or locked closed. The specific valve sleeve shown in the upper drawing of FIG. 11 is a no-lock pneumatic coupler 265 connecting the valve inlet 37 and outlet 42. The middle drawing of FIG. 11 is of a weldable body flange over pressure valve 291. In the single piece valve body with weldable flange 296 the weldable flange 40 is continuous with the valve body 41. The cracking pressure of the over pressure valve 292 is set by the strength of the spring 295. With the over pressure valve 292, the valve inlet 37 and valve outlet 42 are reversed from the above valve. The lower drawing of FIG. 11 is of an O-ring sealed 297 valve sleeve and a valve body ledge 298 that hold the valve in the open position.

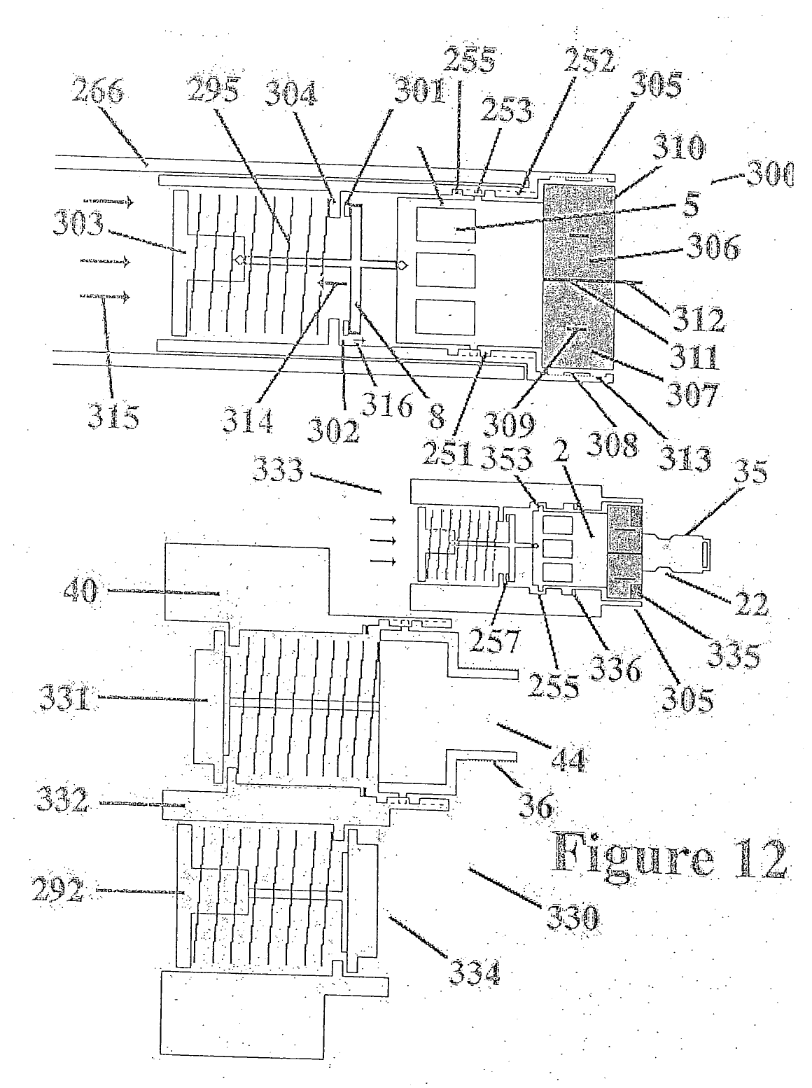

The upper drawing of FIG. 12 illustrates a combined oral inflation, deflation, and over pressure protection valve 300. In the upper drawing a soft compressible inlet and outlet seal 301 regulates flow through a valve inlet/outlet 302. Strength of spring 295 determines cracking pressure. Over pressure relief spring 295 presses against the valve core spring mount 303 at one end while the over end of relief spring 295 stops on valve body spring mount 304. Relief spring 295 creates a tension 314 which holds the valve closed. As seen in the upper drawing, when internal pneumatic pressure 315 exceeds the spring tension 314, the valve opens and the excess pressure 316 is relieved.

In the upper drawing of FIG. 12 valve body indicator window cover 305 allows either the red indicator 306 to show indicating that over pressure protection is locked out or the green indicator 307 portion of valve sleeve 310 is showing indicating that over pressure protection is operable. Within valve body groove 313 a valve body locking ridge 308 interacts with longitudinal, multi-position valve sleeve locking ridge 309 to lock the indicator valve sleeve 310 into the locked position. A central turning ridge and stop 311 complements a turning fin 312 to allow the user purchase of the indicator valve sleeve 310 so that it can be twisted into the locked or unlocked, open or closed positions. When the cam locking quarter turn lock pin 253 is turned into the inner quarter turn groove 255 the pressure applied to fin 312 is translated by the cam into increasing pressure of the soft compressible inlet and outlet seal 301 forced against the seal seat 304.

When valve sleeve quarter turn pin 253 is pulled up valve body quarter turn pin groove 252 the valve seal 301 is pulled away from the valve body seat 304. The operator must pull the valve sleeve up the valve body with a force greater than over pressure spring 295. Once the valve core is pulled up and turned into lock open quarter turn groove 251 it allows easy deflation of compressed gas coming from tube 266 through valve outlet 302 through valve sleeve outlet orifice 5 into the ambient environment. When indicator valve sleeve 310 is neither locked open at groove 251 or closed at groove 255 the spring 295 applies its tension through valve face 8 which keeps seal 301 held against seat 304 with a tension determined by spring 295. In the resting position the valve is a normally closed over pressure relief valve.

In FIG. 12 the middle drawing is of an in-seam, weldable connector with integrated oral inflate, locking deflate, continuous or intermittent over pressure relief valve and locking pneumatic coupler 333. The quarter turn cam pin 353 has been modified to include a cam face that generates increasing pressure on the cam compressible valve seal 257 as the valve sleeve is turned into the quarter turn groove in the valve body 255. When the valve sleeve is turned and locked into the open or inline position seal 336 prevents gas from leaking between the valve body and valve sleeve. When the sleeve is pulled up and locked open to facilitate deflation a third indicator 335 rises above the valve body indicator window cover 305. This brilliant indicator 335 alerts the user that the valve is locked open and needs to be closed before stored.

In the lower drawing of FIG. 12 a weldable body combines connector, inflate valve, locking deflate valve and side by side over pressure relief valve 330. The locking inflate and deflate with threaded pneumatic coupler valve inlet sleeve 331 has a shared wall 332 with over pressure valve 292. Flanges 40 function as a connector. The unobstructed inlet 44 allows the pin found in many Stirred compression couplers to protrude within the valve 331. Alternatively, a tire pump can be screwed onto threads 36 of valve 331. If excessive pressure is built up due to over pumping or solar heating over pressure valve 292 passes the excess gas through outlet 42.

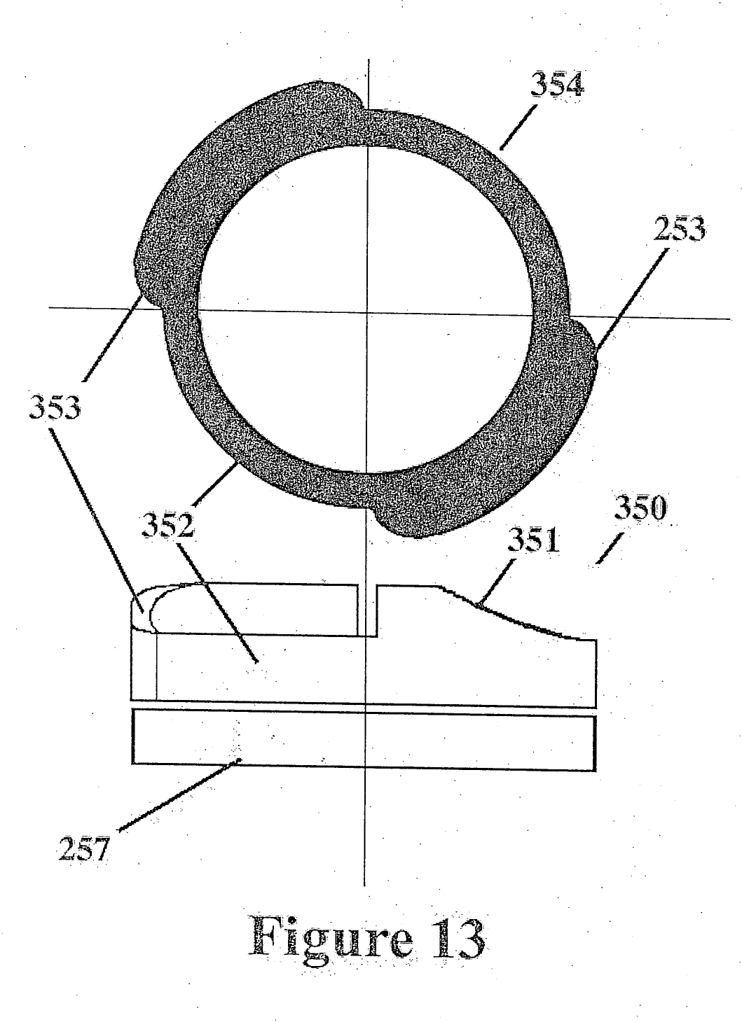

In FIG. 13 is a close up of a valve sleeve 354, which includes a quarter turn pin 253. This pin 253 can also be seen in FIG. 9 within the context of the whole valve. In FIG. 13 the pin which is an extension of valve sleeve body 352 has a modified upper surface 351. The upper face of this the protruding quarter turn pin 253 has an angled surface 351. In FIG. 9 upper drawing can be seen ledge 259 built into the side of the valve body as the cam faced 351 quarter turn pin 253 is turned beneath ledge 259 the increasing thickness of quarter turn cam pin 351 pushes the valve sleeve face against the compressible seal 257, the seal being compressed against valve body stop 256 which can also be seen in FIG. 9.

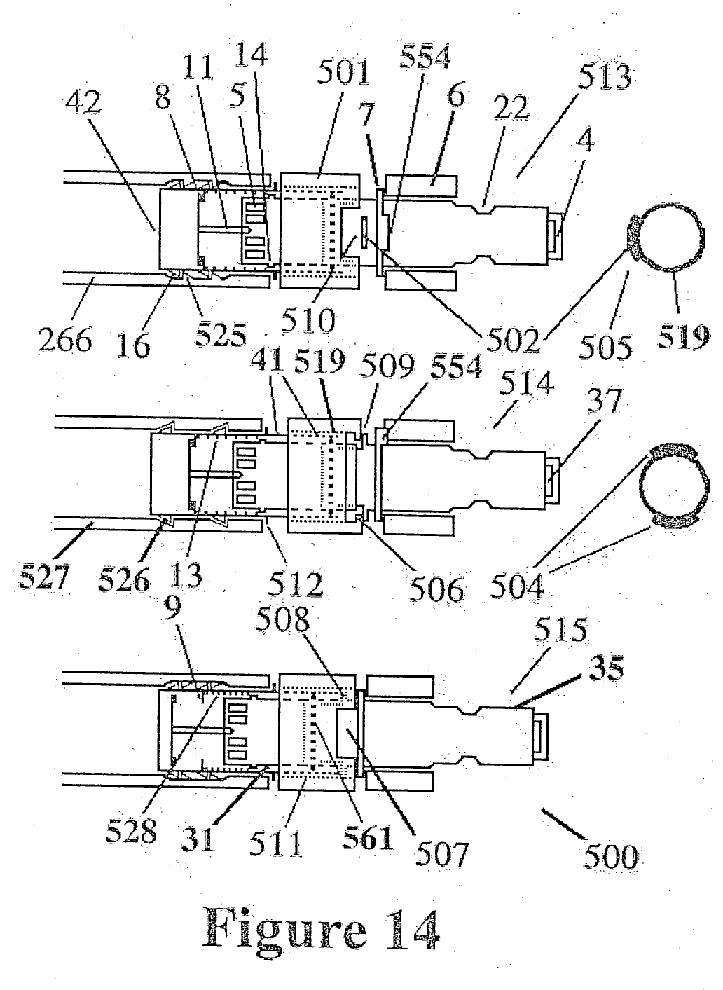

FIG. 14 shows a multifunction valve-coupler 500 installed in tubing connector 266 that can function independently as a normally spring closed oral inflation-deflation valve. The top drawing of FIG. 14 shows the multifunction valve-coupler in the intermittently open mode 513. That is the two piece valve sleeve assembly 519 is free to be pushed inside valve body 41 compressing spring 13 and pushing valve face 8 away from valve body seat 9 to open the valve. In the normally closed intermittently open position 513 the valve face 8 is held compressed against valve seat 9 which also acts as the inner stop for spring 13. The spring pushes against the two-piece valve sleeve assembly 519 at stop 14 on the sleeve body. The valve face 8 is attached by valve post 11 to valve sleeve 519. In the normally closed mode of operation of valve 513 the spring pushes on sleeve 519 that pulls the post 11 and attached face 8 against seat 9. In the intermittent mode of operation mechanical force must be continuously applied to valve sleeve 519 to over come spring 13 to push post 11 and valve face 8 away from seat 9 creating temporary fluid communication from valve inlet orifice 37 through valve sleeve outlet orifice 5 then through temporary opening between valve face 8 pushed away from seat 9 and out the valve outlet 42 and into the bladder connection tubing 266. The lower drawing in FIG. 14 depicts the valve locked open in which sleeve face 8 is held away from body seat 9.

The male key 502 in FIG. 14 determines the valve operation by its position regardless of whether there is a single key 505 as seen rising out of the upper drawing or two male keys 504 as seen in the second drawing rising towards the top and bottom of the page. When the key 502 is locked beneath the key retainer ledge 506 of the outer sleeve 501 a visual indicator 554 locates the key's position as illustrated in the middle figure. Key 502 which is an extension of the two piece sleeve 519 can be pushed away from the valve body 41 by the key retainer 506 portion of the outer sleeve 501 creating a locked closed valve coupler 514, or entrapped by retainer portion 506 against the valve body 41 creating the locked open valve 515 or the key is free to pass 510 between the normally spring closed position to the intermittently open position when the force applied to sleeve assembly 519 is sufficient to overcome spring 13 which normally keeps the sleeve face 8 held against the valve body seat 9. Valve-coupler 513 has traditional barbs 16, which inter-digitate with ridges 525 in tubing connector 266 preventing the valve-coupler 514 from being removed.

The middle drawing of FIG. 14 depicts retainer portion 506 of outer sleeve 501 threaded tight against dual male keys 509. The continuously applied force compresses the valve face 8 against seat 9 placing the valve in the locked closed function 514. The enlargement to the right of the middle drawing illustrates that there are two male keys 504 facing up and down. As the outer sleeve 501 is turned tightly against the key 502 the outer sleeve 501 pushes the two-piece valve sleeve assembly 519 away from the valve body 41. The force against the two-piece sleeve 519 by outer sleeve 501 is transferred through valve post 11 pulling face 8 against seat 9 locking valve coupler 514 in the closed position. The valve body 41 of valve coupler 514 has cutting barbs making removal impossible. The thermally ductile connector 527 is softened prior to installation of valve 514. Once the valve 514 is pushed into connector 527 until valve 514 reaches its tubing insertion stop 512, any force applied to valve 514 that has a vector in the direction of removal digs the sharp barbs 526 into the substance of tubing 527, preventing removal.

In the lower drawing in FIG. 14 the outer sleeve 501 entraps double male key 508 against valve body 41 such that the valve is now permanently locked open 515. The key 502 passes through key way 507 and either the key portion of the valve sleeve is turned under the retainer ledge 506 of the outer sleeve 501 or the outer sleeve 501 is turned by means of threads 511 over the stationary key 502. Either way the two-piece valve sleeve assembly key 502 is entrapped under the outer sleeve ledge 506 and the closure spring held compressed 528. The sleeve assembly 519 with attached face 8 is held away from the valve body seat 9 so that the valve is in the permanently open position 515 and the valve sleeve 519 is sealed off from the environment by coupler O-Ring 561.

In FIG. 14 the run of threaded 511 outer sleeve 501 is limited by valve stop 7, which also serves as a stop for a soft lip guard 6. The two piece valve sleeve assembly 519 includes a locking pneumatic coupler 35 identified by the locking grooves 22 which receive the locking members 548 as seen in FIG. 3 from the female locking quick release valve component 547. Also as seen in FIG. 3 the Schrader bridge 4 of locking coupler 35 depresses the Schrader valve post 552 pushing the Schrader valve face 549 away from the Schrader valve seat 553 opening the Schrader valve 547. The outer sleeve 501 of Valve-Coupler-OPV 546 acting in the opposite direction pushes the two piece valve sleeve away from the valve body 41 locking open the over pressure valve 546 to complete placing the coupled chambers in fluid communication.

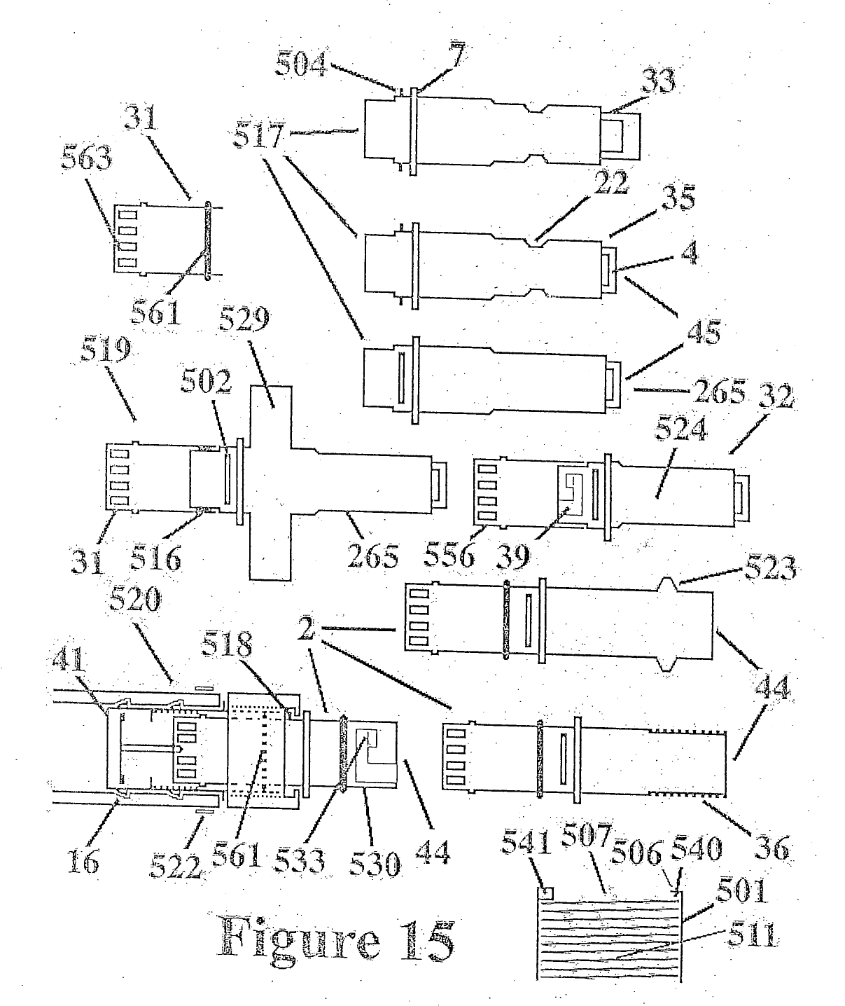

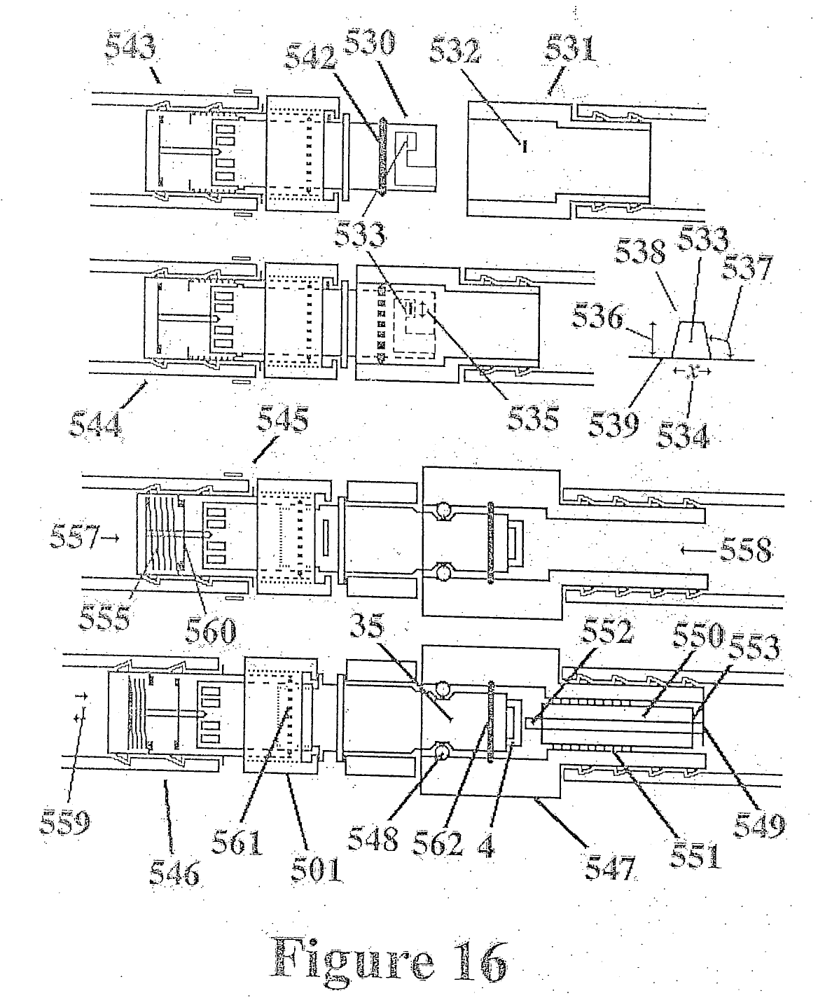

In FIG. 15 a universal receiver valve sleeve 31 can receive a wide range of pneumatic couplers 517 and mounts coupler O-Ring 561 for use when valve is locked open and functioning strictly as pneumatic coupler as seen in FIG. 16. Two-piece construction is required for some valve sleeves when both the inlet 45 and outlet 563 are obstructed. The upper right hand drawing in FIG. 15 is of an extended Schrader bridge 33 that keeps the locking grooves 22 from engaging the locking members 548 as seen in FIG. 16. The middle drawing on the right of FIG. 15 is of a locking pneumatic adapter 35 identified by the presence of locking grooves 22 that are correctly positioned across from the locking members 548 in the quick release valve 547 of FIG. 16. The third drawing on the right of FIG. 15 is of a no-lock pneumatic adapter 265.

The left middle drawing is of a universal base 31 radio frequency welded 516 to a no-lock pneumatic adapter 265 with planar single-handed grasp flange 529. Key 502 allows assembled two-piece valve sleeve 519 to be locked open, closed or operated intermittently. The right middle drawing is an example of the quarter turn mounted adapters 32. In particular a miniature no-lock pneumatic coupler 524 in which there is no soft lip guard 6. A locking quarter turn means 39 allows the universal quarter turn receiver base 556 to mount a wide range of pneumatic adapters 32 both obstructed inlet adapters 45 and un-obstructed adapters 44 as seen below.

The lower group of three drawings of FIG. 15 illustrate that the single piece valve sleeves 2 can be constructed as a single piece because the inlet orifice is unobstructed 44. The upper right hand single-piece valve sleeve is a locking quick release pneumatic coupler 523. The lower right hand single-piece valve sleeve is a threaded valve stem adapter 36 while the lower left hand drawing is of a fully assembled and installed valve 520 including valve sleeve 2 and valve body 41. The valve sleeve 2 includes a locking quarter turn pneumatic coupler 530 with a male locking ridge 533. The assembled valve 520 has traditional removable barbs 16, which require an external mechanical crimp fastener 522. The lowest drawing on the right of FIG. 15 is a detail of the treble function variable position outer sleeve 501. Keyway 507 allows passage of the single or two-piece valve sleeve key 502. With use of right to tighten threads 511 the left side is open 540 to allow entrance of the key 502 under the key retainer ledge 506. This allows for the outer sleeve 501 to increase penetration of the key 502 within the passage 540 as outer sleeve 501 it is tightened. The other side is blocked 541 from allowing the key 502 to enter.

In the top drawing of FIG. 16 a valve coupler with locking quarter turn male adapter 530 is shown in the locked open position 543. The pneumatic coupler 530 is O-Ring sealed 542 and has a male linear locking ridge 533. The complementary female quarter turn coupler 531 has a female quarter turn locking ridge 532. In the second drawing from the top in FIG. 16 the male 530 and female quarter turn coupler 531 are pneumatically sealed with valve-coupler 544 open and in fluid communication. To the right of the second drawing in FIG. 16 is an enlargement of the locking ridge showing the height 536 of the locking ridge 533. As well as the width 534 and angle of incline 537 from the base of the quarter turn groove 539. The length of the locking ridge is indicated in the coupled valve at 535. The strength of the locking quarter turn locking pneumatic coupler 530 and 531 is set to match the connector and bladder and user strength and product application.

The third row drawing of FIG. 16 is a locking pneumatic male adapter 35 and complementary locking female quick release coupler 547. The Valve Coupler OPV valve 545 is in the intermittent position so that integrated lightweight over pressure valve 555 regulates flow. When the air pressure 557 exceeds both the spring strength 555 and the pressure down stream 558 than air flows between the coupled bladders from the zone high-pressure zone 557 to the zone of low pressure 558.

In the fourth row of FIG. 16 is of a locking pneumatic male adapter 35 is sealed by Schrader O-Ring seal 562 and is mechanical secured by locking means 548 within the female quick release component 547. The Schrader bridge 4 depresses Schrader post 552 moving Schrader valve face 549 away from seat 553. Schrader O-ring 562 seals Schrader valve 550 while it is held open. The Valve Coupler OPV 546 with its integrated over pressure valve 560 is locked open by outer sleeve 501 and sealed from the environment by coupler O-Ring 561 converting valve 546 into an unobstructed conduit. With both valves 546 and 550 held open the coupled bladders are in fluid communication in which there is no pressure gradient 559 throughout the system.

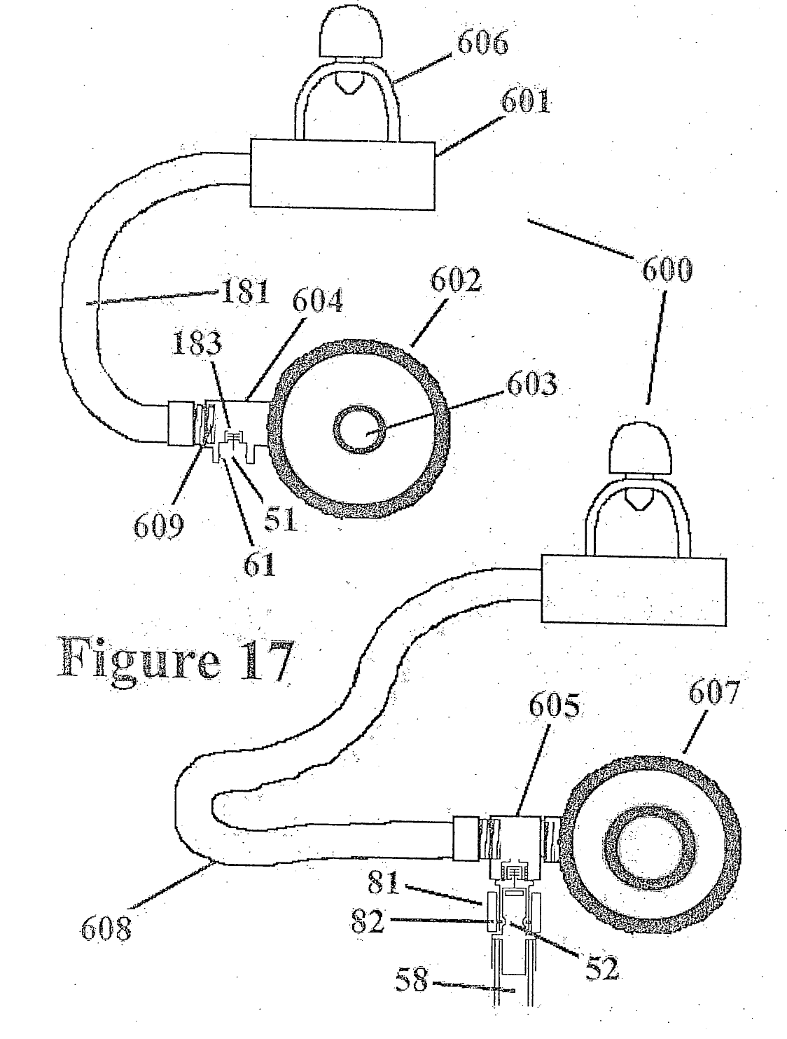

In FIG. 17 the dive regulator includes a port to access 100-psi gas 600. That gas can be compressed air, Nitrox, Tri-Mix or other breathing gas. In the upper left hand drawing the primary stage of the regulator 601 is held to the SCUBA tank by yoke 606. When the tank valve is turned on the primary stage regulator reduces the tank pressure from 3,000 psi to 100 to 150 psi, which is then often called low pressure to distinguish it from the high-pressure gas stored within the tank. The low-pressure gas is passed through low-pressure hose 181 through threaded coupling 609 then passes a no-lock port 51 built into the second stage regulator 604. The valve 604 within the non-locking sleeve 51 is normally closed. As reviewed in FIG. 6 O-ring 61 creates a seal as a pneumatic coupler is held within no-lock pneumatic coupler 51. The compressed gas continues onto the second stage regulator 602. If the second stage regulator 602 is flooded purge button 603 can be depressed to use the compressed air to blow the water out of the regulator.

In the lower right hand drawing of FIG. 17 a longer low-pressure hose 608 connects the back up regulator 607 to the primary stage regulator, which connects to the tank. The use of a longer hose allows the back up regulator 607 to be passed off to a buddy at a greater distance from the primary stage regulator/tank. This addition hose also is useful for positioning the low-pressure port for use in inflating bladders under water or at the surface. Also illustrated in the lower right hand drawing of FIG. 17 is the use of a locking pneumatic coupler 81. In this case the locking coupler 81 include locking ball means 82 to hold the locking male 52 with its receiver ring for balls 82 in fluid communication with the 100 psi gas within low pressure hose 608. This locking coupler 81 allows a life raft attached to the end of conduit 58 to inflate on its own while the diver assists their buddy with both hands.

In particular in the lower drawing the low pressure port is a retrofit model that interposes itself between the back up regulator 607 and the long low-pressure hose 608. The retro fit or add on low pressure port 605 screws into the second stage regulator 607 and receives threaded means 609 securely attached to the low pressure hose 608.

Thus, certain embodiments of the invention provide a pneumatic coupler combined with oral inflation/locking open deflation valve. The locked open position is illustrated in FIG. 14 and can also be included into drawing 9. Item 15 if FIG. 1 is a threaded sleeve that can be turned into a secure position against the Valve and lip cover stop 7 on valve sleeve 2. The flange 7 can act as a dual stop for both the soft lip cover and for the threaded valve lock 15. The soft lip cover 6 can abut against the top of stop 7 and the threaded valve lock 15 is turned up against the bottom surface of 7 to prevent the valve from being accidentally bumped into the open position leading to a loss of pressurized air.

In FIG. 14 threaded valve lock 15 has been modified to include a female keyway 507 which allows passage of the valve sleeve male key 502. There can be a single 519 or multiple male key 504 or 508 with the complementary number of female key ways. Once the male key is passed through the female keyway 507 cut into the threaded valve lock 15, it can then be turned underneath the lip in the threaded valve lock 15. Now the modified threaded valve lock 501 of FIG. 14 can be turned down pulling and holding the valve in the open position so that both hands can be used to roll the bladder towards the open valve where as currently the operator must manually hold the valve open during deflation. Which means that only one hand can be use to roll and compress the bladder during deflation. On large bladders such as a life raft the valve maybe 6 feet away from the end being rolled up during deflation. The ability to lock the valve open significantly improves the routine operation of deflation. The sleeve stop 7 continues to provide an inferior surface against which the modified threaded valve lock 501 can apply pressure to lock the valve closed to prevent accidental deflation during a survival scenario at sea.

The oral inflation deflation valve sleeve which has been modified to include a pneumatic coupler that can be locked open is of benefit not only during deflation but upon inclusion of a valve sleeve O-ring 561 the combined valve coupler can now be used inline. When locked open the O-ring prevents the pressurized fluid from escaping and allows fluid communication across the valve coupler. Yet once the valve coupler is disconnected from the locking or non-locking coupler the integrated valve can be moved from the locked open position into the normally spring closed position or locked closed position as indicated.

Some of the advantages of the invention, include but are not limited to, the following: (1) Single pneumatic coupler combined with oral inflate deflate valve; (2) A range of pneumatic couplers each of which can be reversibly combined with an oral inflate deflate valve; (3) Pneumatic coupler combined with normally closed oral inflate deflate valve; (4) Pneumatic coupler combined with normally closed oral inflate deflate valve with locked open (over riding spring tensioned normally closed valve); (5) Single or multiple pneumatic couplers combined with inflate-deflate valve within sealable valve body; (6) Single or multiple pneumatic couplers combined with inflate-deflate valve with continuous over pressure relief protection; (7) Single or multiple pneumatic couplers combined with inflate-deflate valve with intermittent over pressure relief protection; (8) Single or multiple pneumatic couplers combined with inflate-deflate valve with continuous or intermittent over pressure relief protection; (9) Single pneumatic coupler combined with oral inflate deflate valve within in-seam weldable valve body; (10) Single or multiple pneumatic couplers combined with inflate-deflate valve integrating continuous or intermittent over pressure relief protection within weldable valve body; (11) Single or multiple pneumatic couplers combined with inflate-deflate valve with locking deflate and with continuous or intermittent over pressure relief protection within weldable valve body; (12) Over pressure valve integrating cam lockout over-ride of relief valve; (13) Over pressure valve integrating cam lockout over-ride of relief valve within weldable valve body; (14) Pneumatic coupler combined with oral inflate and locking deflate side by side with OPV within common weldable body; (15) Buoyancy compensator power inflator with add on locking and or non-locking male or female pneumatic couplers; (16) Buoyancy compensator power inflator with integrated locking and or non-locking male or female pneumatic couplers; (17) Buoyancy compensator power inflator with valve regulated pressurized inflation of alternate bladder; (18) Buoyancy compensator power inflator with valve regulated pressurized inflation of surface buoyancy bladder; (19) Buoyancy compensator power inflator with valve regulated pressurized inflation of USCG Approved Personal Flotation Device; (20) Signal tube with dual signal means, distinct locator signal and emergency signal means; (21) Signal tube with triple signal means: distinct locator signal, emergency signal and writing tablet means; (22) Signal tube with connector means use of dive ballast to orient locator signal or emergency signal; (23) Second stage regulator with integrated locking or non-locking low-pressure valve; and (24) Second stage mounted locking or non-locking low-pressure valve.

Index of Reference Numerals for Oral and Compressed Gas Inflate and Deflate Valve

1 Compressed gas coupler combined with oral inflate and deflate valve

2 Single piece oral and compressed gas coupler valve sleeve

3 Pneumatic pump grip ridges

4 Schrader bridge engages low-pressure air supply valve

5 Valve sleeve outlet orifice

6 Soft lip cover

7 Valve and lip cover stop on valve sleeve

8 Valve face normally spring closed

9 Valve seat and spring stop

10 Valve seal

11 Valve post

12 Valve face to valve sleeve connection

13 Valve spring

14 Valve Spring stop

15 Threaded valve lock

16 Barb

20 Two piece valve sleeve construction

21 Adapter stop limiting depth of insertion

22 Locking groove in male component of pneumatic coupler

23 Ultrasonic weld or adhesive

30 Oral inflator-deflator valve mounting interchangeable low-pressure adapters

31 Universal receiver valve sleeve

32 Quarter turn mounted adapters

33 Alternate extended bridge no-lock adapter

34 Mixed use low pressure adapter

35 Locking adapter

36 Valve stem threaded adapter

37 Valve inlet orifice

38 Sleeve mounted O-Ring seal for adapter

39 Quarter turn mount

40 Flared in seam weldable flange

41 Valve Body

42 Valve outlet

43 Inner portion of valve sleeve

44 Unobstructed inlet orifice

45 Outer portion of valve sleeve

50 Buoyancy Compensator power inflator with low pressure supply port

51 No-Lock female pneumatic coupler

52 Locking male pneumatic coupler

53 Normally closed push to open valve

54 Normally closed low-pressure buoyancy compensator inflation valve

55 Conduit supplying low pressure or oral inflation to dive jacket

56 Buoyancy compensator valve body

57 Oral inflation valve button

58 Conduit for pressurized inflation of life raft/distress marker

59 Oral inflation mouthpiece

60 Low pressure chamber in fluid communication with 100 psi primary stage regulator on tank valve stem

61 O-Ring seal

62 Spring closing valve

63 Temporary open position

64 Normally closed position

80 Buoyancy compensator power inflator with locking low pressure supply

81 Quick connect-disconnect locking female low pressure coupler

82 Locking ball means

83 Spring loaded slide

84 Threaded mount for locking female pneumatic coupler

85 Hose with locking male

86 Barbed locking male pneumatic coupler

90 Variable displacement equipment buoy with emergency message signal.

91 Over pressure valve in common connector

92 Single weld connecting compressed gas coupler, oral inflate, deflate and over pressure valve means to bladder

93 SOS Distress Signal

94 Non-traditional high visibility color

95 Spool of line

96 Ascent line

97 Separating reversible closure means

98 Compatible strap mounted integrated ballast connector

99 Integrated ballast pocket connector

100 Quick connect buoyancy compensator pocket

101 Weld baffle to restrict ballooning

102 Width of buoy staff

103 Distress Marker Width

104 Reversible staff mounted attachment means

105 Perimeter reversible complementary attachment means

106 Superior reversible attachment means secured outside of bladder

107 Inferior reversible attachment means secured along bottom of bladder

108 Inflatable staff

109 Equipment support bladder

110 Superior attachment strip

111 Inferior attachment strip

112 Self-lock straps for attaching signal light or for attaching quick release buckle for use of larger bladder for heavier equipment

130 Low displacement marker

131 Integrated ballast T-handle snare

132 Friction lock

133 Straps for attaching range of buckles

134 Warm water medium displacement equipment buoy and marker

135 Pocket dedicated permanently attached quick connect fitting

136 Integrated ballast pocket to BC retaining connector

137 Pair of warm water integrated buoyancy compensator weight pockets with 10 to 20 lbs. of combined

138 Cold water high displacement equipment buoy and marker

139 Buoyancy Compensator integrated weight pocket specific complementary buckle pair

140 Cold water weight pockets with 20-40 lbs.

141 T-handle snare marker-buoy

142 T-handle weight pocket

143 T-handle

145 Message board on fixed low displacement marker

146 Message board and integrated weight pocket on fixed medium displacement buoy

147 Message board and gear bag on fixed high displacement buoy

148 Mesh game/salvage bag

149 Gear bag buckle complementary to ballast pocket/buoy quick connect means

150 Diver emergency-SOS marker, floating tablet, locator tube with fixed high displacement float

151 Diver's weight belt

152 Quick connect weight belt fitting with securely attached complementary buckle

153 Weight belt buckle

154 Folding triple message buoy before rolling

155 Folded message bladder

156 Folded equipment buoy

157 Routine red orange colored background

158 Zipper closed

159 White writing surface on traditional red-orange background

160 Signal flag fully unfolded into SOS-Emergency marker position

161 Marker-buoy tightly rolled

162 Routine weight attachment means, orients locator tube

163 Emergency weight attachment means, orients SOS distress flag

180 Retrofit pair of locking and non-locking female couplers inserted inline between existing buoyancy compensator and low pressure supply line

181 100 psi low pressure hose from primary stage regulator

182 Crimp ferrule

183 Normally closed valve

184 Low pressure supply valve block

200 Buoyancy Compensator with no-lock low-pressure port and intermittent low-pressure supply available for a diver's PFD

201 Normally closed valve regulating air supply to locking female pneumatic coupler

202 Tubing connecting to optional PFD

203 Power inflator manifold with no-lock and locking low pressure ports

204 Optional continuously locked on connection to low pressure chamber placing tube and attached bladder in fluid communication with dive tank

205 Combined pneumatic PFD inflate and BC deflate

206 Threaded tube fitting

207 T fitting

208 Certain buoyancy compensators require optional compressed gas supply to simultaneously venturi deflate buoyancy compensation bladder while inflating PFD bladder

209 Tubing connecting mandatory PFD

210 PFD inflation button of valve 201

211 Cable for manual deflation of buoyancy compensation bladder

220 Internal pneumatic buoyancy compensator deflate supply line

221 Spring biased over pressure valve

222 Normally closed deflate orifice

223 Transiently open deflate orifice

224 Continuously open low pressure input and output

225 Large bore high flow rate coupler to buoyancy compensator jacket

226 Manual buoyancy compensator deflate valve

227 Normally closed pneumatic ram

228 Intermittent pneumatic deflation valve

250 Normally closed, alternatively can be locked open or locked closed insert valve

251 Locked-open quarter turn groove in body of valve

252 Longitudinal quarter turn pin track

253 Quarter turn lock pin

255 Cam locking closed quarter-turn groove in body of valve

256 Inlet pneumatic coupler stop in body of valve

257 Cam compressible valve seal

258 Insert depth stop

259 Quarter turn ledge in valve body

260 Valve post compression lock

261 Valve face seal and outlet assembly

262 Valve core outlet mounting plate

263 Valve core outlet face and seal

264 Valve seal mechanical mount

265 No-lock adapter valve sleeve

266 Bladder connection tube

267 Insert-valve

268 Adhesive between valve core outlet to valve seal

270 Extended length valve sleeve adapter

271 Grid mounting compression lock

272 Grid fenestration

273 Reduced lateral deflection gap

274 Bi-directional cutting edged barbs

280 Selection of valve sleeve-adapters for locking inflate-locking deflate, locking closed, insert valves

290 Weldable flange embedding combined connector-coupler with locking inflate locking deflate valve

291 Weldable body flange-connector and over pressure relief valve

292 Over pressure relief valve

294 Valve body embedded in weldable flange

295 Over pressure spring

296 Single piece valve body with weldable flange

297 O-ring sealed locking open valve sleeve

298 Valve body locking ledge

300 Combined over pressure and oral inflate-locking deflate valve

301 Soft compressible inlet and outlet seal

302 Valve inlet or outlet

303 Spring valve core mount

304 Valve body spring mount and seal seat

305 Valve body indicator window cover

306 Red Indicating valve locked open or closed with over pressure protection locked out

307 Green indicating over pressure protection locked on

308 Longitudinal, multi-position valve body locking ridge

309 Longitudinal, multi-position valve sleeve locking ridge

310 OPV Indicator valve sleeve

311 Turning ridge and stop

312 Turning fin

313 Valve body groove for valve sleeve ridge before and after valve body ridge lock

314 Spring tension sets cracking pressure

315 Internal pneumatic pressure

330 Weldable body combines connector, inflate valve, locking deflate valve and side by side over pressure relief valve.

331 Locking inflate and deflate with threaded pneumatic coupler valve inlet sleeve

332 Common valve body wall

333 In-seam weldable connector with integrated oral inflate, locking deflate, continuous or intermittent over pressure relief valve and locking pneumatic coupler

334 Over pressure release outlet

335 Brilliant contrasting valve-locked-open indicator

336 Locked open seal

350 Cam compressed seal for locking inflate

351 Cam face compresses seal on turning

352 Non-locking portion of valve sleeve

353 Cam locking quarter turn pin an extension of valve sleeve into the valve body

354 Valve sleeve

370 Non-locking coupler and locking deflate

371 Intermittent oral inflate and locking deflate

372 Locking pneumatic coupler locking inflate and locking deflate

373 Locking coupler with locking inflate and locking deflate

374 Valve body mounted O-Ring

500 Locking-Open, Locking-Closed and Spring Loaded Intermittent External Valve with Integrated Pneumatic Coupler

501 Treble function variable position outer sleeve

502 Male key

504 Dual male key facing to top and bottom of page

505 Single male key facing out of page

506 Key retainer ledge of outer sleeve

507 Female key way in outer sleeve

508 Double male key locked in valve open position

509 Double male key locked in valve closed position

510 Single male key in normally spring closed intermittently open position

511 Threads between valve body and outer sleeve

512 Tube insertion depth stop and locking outer sleeve lower stop

513 Spring closed valve-coupler

514 Locked closed valve-coupler

515 Locked open valve-coupler

516 Ultrasonic weld

517 Pneumatic coupler portion of the valve sleeve

518 Single male key locked open

519 2 piece valve sleeve assembly

520 Fully assembled and installed single piece sleeve and valve body

521 Double male key with one key facing out of the page

522 External mechanical crimp fastener

523 Quick lock, unobstructed single-piece valve sleeve, pneumatic coupler

524 Miniature Non-Lock pneumatic coupler

525 Locking inner complementary surface of tube

526 Crimpless non-removable over-sized cutting-edged barb

527 Thermally ductile connector

528 Compressed spring

529 Planar single handed grasp flange

530 Quarter turn locking pneumatic male coupler

531 Quarter turn locking pneumatic female coupler

532 Female quarter turn locking ridge

533 Male linear locking ridge

534 Linear locking ridge width

535 Linear locking ridge length

536 Linear locking ridge height

537 Linear locking ridge angle of incline

538 Enlarged locking ridge detail

539 Base of quarter turn groove

540 Key passage access side

541 Blocked outer sleeve lip

542 Adapter O-Ring seal

543 Locked open valve with quarter turn locking coupler

544 Inline fluid communication coupler, valve locked open.

545 Inline coupler with over pressure valve regulating flow

546 In line coupler with over pressure valve locked open placing coupled chambers in fluid communication.

547 Locking female component of quick release valve

548 Locking element

549 Schrader valve face

550 Schrader valve, normally spring closed

551 Threaded mount for Schrader valve

552 Schrader valve face post

553 Schrader valve seat

554 Key location indicator

555 Very light weight spring of Over Pressure valve

556 Quarter turn female receiver component of the valve sleeve

557 Zone of high pressure

558 Zone of low pressure

559 No pressure gradient

560 Over Pressure Valve

561 Coupler O-Ring

562 Schrader O-Ring

563 Valve outlet obstructed by valve post mount

600 Dive regulator integrating a port to access 100 psi gas

601 Primary stage of dive regulator

602 Secondary stage of main dive regulator

603 Purge button

604 Integrated No-lock 100 psi port, built into second stage regulator

605 Add-on 100 psi locking port interposed between low pressure hose and secondary stage regulator

606 Yoke for attaching to SCUBA cylinder

607 Back up secondary stage regulator or octopus regulator

608 Extra long 100 psi hose

609 Threaded coupling between 100 psi hose and second stage regulator

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An inflation/deflation valve, comprising:
a valve body having an internal passageway and a valve outlet end, said valve body having a valve seat disposed within the internal passageway;
a valve sleeve having an outlet end disposed within the internal passageway of said valve body, said valve sleeve having an internal passageway;
a valve face attached to said valve sleeve at the perforated outlet end of said valve sleeve, and
a spring having a spring tension and disposed within the internal passageway of said valve body; said spring maintaining said valve face in an abutting relationship with said valve seat unless a force greater than the spring tension is applied to prevent gas from flowing through the internal passageway of said valve body.

2. The inflation/deflation valve of claim 1 wherein said valve sleeve having means for activating a pneumatic supply for receiving gas within the internal passageway of said valve sleeve.

3. The inflation/deflation valve of claim 2 wherein said valve sleeve having an outer surface which provides non-locking coupling of said valve sleeve to said pneumatic supply.

4. The inflation/deflation valve of claim 2 wherein said valve sleeve having an outer surface having a locking groove for receipt of one or more locking balls to provide for locked coupling of said valve sleeve to said pneumatic supply.

5. The inflation/deflation valve of claim 2 wherein said means for activating is an actuating bridge disposed at an exposed inlet end of said valve sleeve.

6. The inflation/deflation valve of claim 2 wherein said means for activating comprising:
an adaptor having an exposed inlet end, said adaptor removably connected to said valve sleeve at an inlet end of said valve sleeve; and
an actuating bridge disposed at the exposed inlet end of said adaptor.

7. The inflation/deflation valve of claim 6 wherein said adaptor having an outer surface which provides non-locking coupling of said valve sleeve to said pneumatic supply.

8. The inflation/deflation valve of claim 6 wherein said adaptor having an outer surface having a locking groove for receipt of one or more locking balls to provide for locked coupling of said valve sleeve to said pneumatic supply.

9. The inflation/deflation valve of claim 1 wherein said valve sleeve having a pin member and said valve body having an internal groove; wherein when said pin member is disposed within said internal groove said valve face is maintained in a non-abutting position with respect to said valve seat to permit gas flow through the internal passageway of said valve body.

10. The inflation/deflation valve of claim 1 wherein said valve sleeve having a pin member and said valve body having an internal groove; wherein when said pin member is disposed within said internal groove said valve face is maintained in a abutting position with respect to said valve seat to prevent gas flow through the internal passageway of said valve body.

11. The inflation/deflation valve of claim 1 wherein said valve sleeve having a ridge disposed on an outer surface and said spring is disposed between said valve seat and said ridge.

12. The inflation/deflation valve of claim 1 wherein said valve sleeve having a stop member disposed on its outer surface to restrict inward movement of said valve sleeve within the internal passageway of said valve body to a specific length.

13. The inflation/deflation valve of claim 12 further including means for locking said valve seat and said valve face in a closed sealed position.

14. The inflation/deflation valve of claim 13 further including means for locking said valve seat and said valve face in an open non-sealed position.

15. The inflation/deflation valve of claim 1 wherein the outlet end of said valve sleeve is perforated.

16. The inflation/deflation valve of claim 1 wherein said valve body having an outer surface having one or more barbs disposed on a portion thereof for securing the valve body to a tubing.

17. The inflation/deflation valve of claim 1 further including a weldable flange attached to said valve body for attaching said valve body to an inflatable object.

18. The inflation/deflation valve of claim 2 further including an o-ring disposed on said valve sleeve for providing a sealed relationship between said valve sleeve and a coupled pneumatic supply.

19. The inflation/deflation valve of claim 13 wherein said means for locking is a valve lock threadedly attached to said valve body; wherein in a closed sealed position said valve lock is positioned on said valve body to be in an abutting relationship with the stop member which prevents the valve sleeve from being movable inward with respect to the internal passageway of said valve body.

20. The inflation/deflation valve of claim 14 wherein said means for locking comprising:
a valve lock threadedly attached to said valve body, said valve lock defining a keyway; and
a key disposed on said valve sleeve;
wherein in a closed sealed position said valve lock is positioned on said valve body to be in an abutting relationship with the stop member which prevents the valve sleeve from being movable inward with respect to the internal passageway of said valve body and in an open non-sealed position said valve lock is positioned on said valve such that the keyway receives and retains the key which maintains the valve sleeve in the open non-sealed position.

21. The inflation/deflation valve of claim 17 further comprising an overpressure relief valve having a relief valve body attached to said weldable flange for attaching said relief valve body to the inflatable object.

22. The inflation/deflation valve of claim 21 wherein said valve body and said relief valve body share a common wall such that the inflation/deflation valve and the overpressure relief valve are in a side-by-side relationship.

23. A power inflator comprising:
a body member having an internal chamber, first gas travel path in communication with the internal chamber, a second gas travel path in communication with the internal chamber
a conduit in communication with said first gas travel path;
a mouthpiece in communication with said second gas travel path;
means for providing controlled gas supply into the internal chamber from a compressed gas supply; and
a female port in communication with the internal chamber through a valve; said female port coupling an inserted male portion of a pneumatic valve connected to an inflatable object;
wherein proper insertion of the male portion of the pneumatic valve into the female port causes the female port valve to permit gas disposed within the internal chamber to travel through the pneumatic valve and into the connected inflatable object.

24. The power inflator of claim 23 wherein said female port provides non-locking coupling of the male portion.

25. The power inflator of claim 23 wherein said female port including at least one locking ball which is received within a locking groove of said male portion for providing a locked coupling relationship between said female port and the male portion when the male portion is properly inserted within the female port.

26. The power inflator of claim 23 wherein said female port further including an o-ring disposed therein for providing a sealed relationship between the female port and the male portion when the male portion is properly inserted within the female port.

27. The power inflator of claim 23 further comprising a second female port in communication with said internal chamber through a manually operated valve.

28. A second stage regulator comprising:
a body member having an internal chamber in communication with a hose port and a back-up regulator port;
a female port in communication with the internal chamber through a valve; said female port coupling an inserted male portion of a pneumatic valve connected to an inflatable object.

29. The second stage regulator of claim 28 wherein said female port provides non-locking coupling of the male portion.

30. The second stage regulator of claim 28 wherein said female port including at least one locking ball which is received within a locking groove of said male portion for providing a locked coupling relationship between said female port and the male portion when the male portion is properly inserted within the female port.

31. The second stage regulator of claim 28 wherein said female port further including an o-ring disposed therein for providing a sealed relationship between the female port and the male portion when the male portion is properly inserted within the female port.

32. The second stage regulator of claim 28 further including an elongated hose attached at one end to the hose port of the body member and at its opposite end to a primary stage regulator.
